(19) United States
(12) Patent Application Publication
(10) Pub. No.: US 2025/0120404 A1
(43) Pub. Date: Apr. 17, 2025

(54) BOTANICAL PESTICIDE COMPOSITIONS

(71) Applicant: Mosquito Squad Franchising SPE LLC, Columbia, MD (US)

(72) Inventor: Kurt Vandock, Creedmoor, NC (US)

(21) Appl. No.: 18/487,012

(22) Filed: Oct. 13, 2023

(51) Int. Cl. A01N 65/06; A01N 65/12; A01N 65/22; A01N 65/28; A01P 7/04

(52) U.S. Cl. CPC A01N 65/06; A01N 65/12; A01N 65/22; A01N 65/28; A01P 7/04

(57) ABSTRACT

Disclosed herein are compositions, such as botanical pesticide compositions, comprising mixtures of botanical extracts. Additionally, disclosed are methods for using botanical pesticide compositions, such as in the control of insect populations.

### FIELD OF THE INVENTION

This disclosure generally relates to compositions of botanical pesticides. Such compositions include botanical extracts, such as at least one herbal extract, nut extract, seed extract, or tree or shrub extract, including combinations thereof. The disclosure additionally relates to methods of using disclosed botanical pesticide compositions, such as in the control of insect populations.

### BACKGROUND

Conventional pesticides, including mosquito insecticides, pose significant dangers to human health and the environment. Commercially available synthetic formulations often contain ingredients that are detrimental to the environment and toxic to humans. For example, prolonged exposure to such pesticides has been linked to various health problems, including respiratory issues, neurological disorders, and even cancer. Moreover, the widespread use of conventional pesticides has adversely affected beneficial insect populations and contributed to pesticide resistance, resulting in diminished utility and uncontrolled insect populations.

Plant-based or natural pesticides, such as compositions containing plant extracts, have been explored as alternatives to conventional pesticides. While more environmentally friendly, such plant-based formulations are not without shortcomings. For example, such natural pesticides may have limited efficacy or lack the stability to persist in the environment and provide long-lasting protection from insect pests. Additionally, the production and application of plant-based pesticides can be costly and logistically challenging, hindering their widespread adoption. Accordingly, there exists a need to provide plant-based pesticides, such as botanical pesticides, with enhanced efficacy. There further exists a need to provide botanical pesticides that are long-lasting, e.g., having sustained residual activity following application to a surface. Among other features, such advantages can reduce costs and consumer involvement, thereby encouraging use of such compositions. Aspects of the invention disclosed herein address these needs.

### INCORPORATION BY REFERENCE

Each patent, publication, and non-patent literature cited in the application is hereby incorporated by reference in its entirety as if each was incorporated by reference individually, and as if each is fully set forth herein. However, where such reference is made, and whether to patents, publications, non-patent literature, or other sources of information, it is for the general purpose of providing context for discussing features of the invention. Accordingly, unless specifically stated otherwise, the reference is not to be construed as an admission that the document or underlying information, in any jurisdiction, is prior art, or forms part of the common general knowledge in the art.

### SUMMARY OF THE INVENTION

A first aspect of the invention includes a botanical pesticide composition, such as for control of an insect population.

A second aspect of the invention includes a method for controlling an insect population, such as by spraying a botanical pesticide composition as described herein onto a surface that is contacted or available for contact by the insect population.

A first embodiment is a botanical pesticide composition including a Juniperus extract and/or a Cedrus extract, a Syzygium extract, and a horticultural oil.

A second embodiment is a botanical pesticide composition further including a Mentha extract and/or a Thymus extract.

A third embodiment is a botanical pesticide composition, where a) the Juniperus extract is an oil including 10-50% α-cedrene and/or the Cedrus extract is an oil including 10-50% α-cedrene; b) the Syzygium extract is an oil including 25-75% eugenol, and c) the horticultural oil includes an oil selected from a vegetable oil, a mineral oil, a petroleum oil, and combinations thereof, and where the vegetable oil includes sesame seed oil including 5-25% sesamolin.

A fourth embodiment is a botanical pesticide composition where the Mentha extract is an oil including 20-60% menthol; and the Thymus extract is an oil including 25-75% thymol.

A fifth embodiment is a botanical pesticide composition further including a preservative and/or a surfactant.

A sixth embodiment is a botanical pesticide composition including cedarwood oil, clove oil, and sesame seed oil.

A seventh embodiment is a botanical pesticide composition further including peppermint oil and thyme oil.

An eighth embodiment is a botanical pesticide composition further including an antimicrobial agent and/or a surfactant.

A ninth embodiment is a botanical pesticide composition where the antimicrobial agent is selected from benzoic acid, propionic acid, sorbic acid, and combinations thereof; and the surfactant is selected from the group consisting of sodium dodecyl sulfate (SDS), sodium lauryl sulfate (SLS), sodium laureth sulfate (SLES), and combinations thereof.

A tenth embodiment is a botanical pesticide composition where the cedarwood oil includes 10-50% α-cedrene and is present in a % v/v amount of 0.1%-10%, b) the clove oil includes 25-75% eugenol and is present in a % v/v amount of 0.1%-10%, and c) the sesame oil includes 5-25% sesamolin and is present in a % v/v amount of 0.1%-10%, where each range is inclusive.

An eleventh embodiment is a botanical pesticide composition where a) the peppermint oil includes 20-60% menthol and is present in a % v/v amount of 0.1%-10%, and b) the thyme oil includes 25-75% thymol and is present in a % v/v amount of 0.1%-10%, where each range is inclusive.

A twelfth embodiment is a botanical pesticide composition where propionic acid is present in a % v/v amount of 0.1-25% and sodium lauryl sulfate (SLS) is present in a % v/v amount of 0.1-5%, where each range is inclusive.

A thirteenth embodiment is a botanical pesticide composition including geraniol, a Rosmarinus extract, and a Syzygium extract.

A fourteenth embodiment is a botanical pesticide composition where a) the Rosmarinus extract is an oil including 20-60% 1,8-cineole and b) the Syzygium extract is an oil including 25-75% eugenol.

A fifteenth embodiment is a botanical pesticide composition further including a Cedrus extract and/or a Juniperus extract.

A sixteenth embodiment is a botanical pesticide composition where the Cedrus extract is an oil including 10-50% α-cedrene and/or the Juniperus extract is an oil including 10-50% α-cedrene.

A seventeenth embodiment is a botanical pesticide composition including geraniol, rosemary oil, and clove oil.

An eighteenth embodiment is a botanical pesticide composition including geraniol, rosemary oil, and clove oil in equivalent amounts, such as a 1:1:1 volume ratio.

A nineteenth embodiment is a botanical pesticide composition including geraniol, rosemary oil, and clove oil, each in an amount of 1-10% (v/v).

A twentieth embodiment is a botanical pesticide composition including geraniol, rosemary oil, cedarwood oil, and clove oil.

A twenty-first embodiment is a botanical pesticide composition including geraniol, rosemary oil, cedarwood oil, and clove oil in an equivalent amount, such as a 1:1:1:1 volume ratio.

A twenty-second embodiment is a botanical pesticide composition including geraniol, rosemary oil, cedarwood oil, and clove oil, each in an amount of 1-10% (v/v).

A twenty-third embodiment is a botanical pesticide composition of any of the preceding embodiments further including a horticultural oil, where the horticultural oil includes an oil selected from a vegetable oil, a mineral oil, a petroleum oil, and combinations thereof.

A twenty-fourth embodiment is a botanical pesticide composition of any of the preceding embodiments further including an antimicrobial agent, a preservative, a surfactant, or a combination thereof.

A twenty-fifth embodiment is a method of controlling an insect population by spraying the composition of any of the preceding embodiments onto a surface that is contacted or available for contact by the insect population, thereby controlling the insect population.

A twenty-sixth embodiment is a method of controlling an insect population, where controlling the insect population includes repelling an insect in the insect population, killing an insect in the insect population, or a combination thereof.

A twenty-seventh embodiment is a method of controlling an insect population, including repeatedly spraying the composition of onto the surface.

A twenty-eighth embodiment is a method of controlling an insect population, where the spraying is repeated at least about every one week, at least about every two weeks, at least about every three weeks, at least about every four weeks, at least about every five weeks, or at least about every six weeks.

A twenty-ninth embodiment is a method of controlling an insect population where spraying the composition onto the surface is repeated about every 7 days, every 14 days, every 21 days, every 28 days, or every 35 days.

A thirtieth embodiment is a method of controlling an insect population where the insect population is a mosquito population.

A thirty-first embodiment is a method of controlling an insect population where the mosquito population includes a mosquito selected from a genus selected from Aedes, Anopheles, Coquillettidia, Culex, Culiseta, and Psoraphora.

A thirty-second embodiment is a method of controlling an insect population where the mosquito is selected from the group consisting of Aedes aegypti, Aedes albopictus, Anopheles freeborni, Anopheles quadrimaculatus, Culex pipiens, Culex quinquefasciatus, Culex restuans, Culex salinarius, Culex tarsalis, Culiseta inornate, Culiseta melaura, Coquillettidia perturbans, Psorophora ciliata, and Psorophora columbiae.

### BRIEF DESCRIPTION OF THE FIGURES

The accompanying drawings are included to provide a further understanding of the disclosure and are incorporated in and constitute a part of this specification, illustrate embodiments, and together with the description serve to explain the principles of the disclosure.

FIG. 1A. Bar graph showing percent Aedes vexans mosquito death during exposure (15 minutes) and post-exposure (1 hour and 24 hours) to tile freshly glazed (Day 0) with botanical essential oil compositions relative to an untreated control.

FIG. 1B. Bar graph showing percent Aedes vexans mosquito death during exposure (15 minutes) and post-exposure (1 hour and 24 hours) to tile previously glazed (Day 7) with botanical essential oil compositions relative to an untreated control.

FIG. 1C. Bar graph showing percent Aedes vexans mosquito death during exposure (15 minutes) and post-exposure (1 hour and 24 hours) to tile previously glazed (Day 14) with botanical essential oil compositions relative to an untreated control.

FIG. 1D. Bar graph showing percent Aedes vexans mosquito death during exposure (15 minutes) and post-exposure (1 hour and 24 hours) to tile previously glazed (Day 21) with botanical essential oil compositions relative to an untreated control.

FIG. 2A. Bar graph showing percent Culex pipiens mosquito death during exposure (15 minutes) and post-exposure (1 hour and 24 hours) to tile freshly glazed (Day 0) with botanical essential oil compositions relative to an untreated control.

FIG. 2B. Bar graph showing percent Culex pipiens mosquito death during exposure (15 minutes) and post-exposure (1 hour and 24 hours) to tile previously glazed (Day 7) with botanical essential oil compositions relative to an untreated control.

FIG. 2C. Bar graph showing percent Culex pipiens mosquito death during exposure (15 minutes) and post-exposure (1 hour and 24 hours) to tile previously glazed (Day 14) with botanical essential oil compositions relative to an untreated control.

FIG. 2D. Bar graph showing percent Culex pipiens mosquito death during exposure (15 minutes) and post-exposure (1 hour and 24 hours) to tile previously glazed (Day 21) with botanical essential oil compositions relative to an untreated control.

FIG. 3A. Bar graph showing percent Aedes vexans mosquito death during exposure (15 minutes) and post-exposure (1 hour and 24 hours) to tile freshly glazed (Day 0) with botanical essential oil compositions relative to an untreated control.

FIG. 3B. Bar graph showing percent Aedes vexans mosquito death during exposure (15 minutes) and post-exposure (1 hour and 24 hours) to tile previously glazed (Day 7) with botanical essential oil compositions relative to an untreated control.

FIG. 3C. Bar graph showing percent Aedes vexans mosquito death during exposure (15 minutes) and post-exposure (1 hour and 24 hours) to tile previously glazed (Day 14) with botanical essential oil compositions relative to an untreated control.

FIG. 3D. Bar graph showing percent Aedes vexans mosquito death during exposure (15 minutes) and post-exposure (1 hour and 24 hours) to tile previously glazed (Day 21) with botanical essential oil compositions relative to an untreated control.

FIG. 4A. Bar graph showing percent Culex pipiens mosquito death during exposure (15 minutes) and post-exposure (1 hour and 24 hours) to tile freshly glazed (Day 0) with botanical essential oil compositions relative to an untreated control.

FIG. 4B. Bar graph showing percent Culex pipiens mosquito death during exposure (15 minutes) and post-exposure (1 hour and 24 hours) to tile previously glazed (Day 7) with botanical essential oil compositions relative to an untreated control.

FIG. 4C. Bar graph showing percent Culex pipiens mosquito death during exposure (15 minutes) and post-exposure (1 hour and 24 hours) to tile previously glazed (Day 14) with botanical essential oil compositions relative to an untreated control.

FIG. 4D. Bar graph showing percent Culex pipiens mosquito death during exposure (15 minutes) and post-exposure (1 hour and 24 hours) to tile previously glazed (Day 21) with botanical essential oil compositions relative to an untreated control.

### DETAILED DESCRIPTION

In view of the disadvantages associated with conventional synthetic pesticides, research into household-safe and environmentally-friendly alternatives has expanded. In particular, the pesticidal capacity of botanical extracts has been explored. For example, in 1950, Heal et al. reported the toxic activity in insects of approximately 2,500 plants, belonging 247 plant families (Heal et al., Lloydia 1950; 13(2):89-162). Today, 71 years later, this list is even longer. However, deficiencies of such studies, including lack of reproducibility and variable efficacy, have been noted as barriers to advancement of knowledge and commercialization for pesticidal use. See, e.g., Isman & Grieneisen, Trends Plant Sci. 2014 March; 19(3):140-5. Accordingly, botanical pesticide compositions having reliable and sustained efficacy may provide various advantages over currently available options.

Various types of plant extracts, such as botanical extracts have been studied, and each type of extract has a distinct method of manufacturing and unique properties resulting therefrom. For example, essential oils are typically extracted from plant material through methods like steam distillation or solvent extraction. These processes aim to capture the volatile aromatic compounds of the plants, which contain a complex mixture of bioactive compounds specific to the source of extraction. See, e.g., the isolation and chemical characterization of peppermint essential oil by Zhao et al., Biomed Pharmacother. 2022 October; 154:113559 and the isolation and chemical characterization of thyme essential oil by Borugă et al, J Med Life. 2014; 7(Spec Iss 3): 56-60.

Botanical oil extracts may also be obtained by cold-pressing, which is used in the manufacture of carrier oils. Carrier oils, which are also referred to as cold-pressed oils, contain lipid extracts from a botanical source, such as the seeds of plants. Typical carrier oils are derived from the seeds, kernels, or nuts of a plant, such as sesame seed oil, coconut oil or avocado oil.

Botanical oil extracts can undermine the survival of insect pests in a variety of ways. In one example, vegetable oils, such as horticultural vegetable oils, can block spiracles and promote asphyxiation. Spiracles are respiratory openings on an insect's thorax and abdomen that are connected to the trachea and facilitate diffusion of oxygen. Aside from a physical smotherant effect, the repertoire of bioactive compounds in a botanical oil, such as an essential oil, can interfere with an insect's nervous system, such as the cholinergic system and the octopaminergic system, along with insect metabolism. See, e.g., Enan, Comp. Biochem. Physiol. Part C Toxicol. Pharmacol. 2001; 130:325-337; De-Oliveira et al., Toxicol. Lett. 1997; 92:39-46; Rants'o et al., Molecules. 2022 October; 27 (20): 7026.

Hydrosols or floral waters are another type of botanical extract, which are produced by distilling plant material. See, e.g., Bayhan et al., GMS Hyg Infect Control. 2020 Sep. 7; 15:Doc21. While sometimes prepared by the same process used to manufacture essential oils, hydrosols are distinct from essential oils in that they are predominately composed of hydrophilic compounds. See, e.g., Price et al.'s “Understanding Hydrolats: The Specific Hydrosols for Aromatherapy: A Guide for Health Professionals.” Also containing predominately water-soluble compounds, decoctions are produced by boiling or simmering plant material in water.

While decoctions involve at least simmering plant material in water, infusions are prepared by steeping plant material in hot water. The preparation of other extracts, such as tinctures, involves soaking a botanical material in a solvent, such as alcohol or glycerin in the presence or absence of water, to extract hydrophilic and hydrophobic constituents thereof. The preparation of any such extracts may also involve straining or filtering the collected extract.

Botanical extracts have been studied to evaluate their toxic capacity in several different types of insects, including mosquitoes. For example, Sukumar et al. listed 344 plant species that were toxicants, growth and reproduction inhibitors, repellents, and ovipositional deterrents (Sukumar et al., J Am Mosq Control Assoc. 1991 June; 7(2):210-37). See also, e.g., Ghosh et al., Indian J Med Res. 2012 May; 135(5):581-598; Shaalan et al., Environ Int. 2005 October; 31(8):1149-66; Kishore et al., Kerala: Research Signpost; 2011. pp. 335-65; Pavela, Industrial Crops and Products, 2015; 76:174-187, Vargas, Boletin de Malariologia y Salud Ambiental. 2012 Ago; 52(2): 143-193. In a summary of representative literature, the relative potencies of botanical essential oils, specifically relating to the toxicity of essential oils against mosquitoes, are ranked in Table 1. The ranking is based on average reported toxicity reported as concentration/biomass (μg/g mosquito weight). Those noted “varying levels” were found to have varying levels of toxicity against mosquitoes, and toxicity was measured according to different metrics, e.g., by mass or by surface area of exposure. Notably, the majority of studies in the literature involve contacting the mosquitoes via fumigation, which lacks residual activity.

TABLE 1
Insecticidal capacity of botanical essential oils

| | Concentration of Oil |
|---|---|
| | Extract Necessary for |
| | Mosquito Death |
| Botanical Oil Extract | (μg/g mosquito weight) |
| Thyme and thyme oil | 3400 |
| Cinnamon and cinnamon oil | 3500 |
| Cloves and clove oil | 4100 |
| Eugenol (primary component of clove oil) | Varying levels |
| Citronella and citronella oil | 4500 |
| Lemongrass oil | 4900 |
| Geraniol (primary component of citronella oil) | Varying levels |
| Geranium oil | 6000 |
| Cedar oil | 10700 |
| Mint and mint oil | Varying levels |
| Peppermint and peppermint oil | 12700 |
| Garlic and garlic oil | Varying levels |
| 2-phenethyl proprionate | Varying levels |
| Rosemary and rosemary oil | 33000 |

Most, but not all, of the reviewed plant extracts, such as the botanical oil extracts shown in Table 1, are not on the USA EPA 25b list of minimum risk pesticides. The EPA has compiled a list of active and inert ingredients that are deemed “minimum risk pesticides,” which have been determined to pose little to no risk to human health or the environment. Accordingly, pesticide formulations containing minimum risk ingredients, such as compositions disclosed herein, would offer an assurance of safety, in both household and environmental contexts, over compositions containing toxic and environmentally harmful ingredients.

As defined by the EPA, the term “pesticide” is broad and includes compositions and products that do not cause insect death, such as insect repellents, along with those that exert insecticidal activity. Accordingly, the compositions disclosed herein may act as insect repellents, which may or may not require direct contact between the disclosed composition and the insect. Insect repellents may be effective in preventing, destroying, repelling, or mitigating any pest, and the insect repelling activity of a substance, such as a disclosed composition, may be assessed in accordance with assays available to one of skill in the art, including, e.g., arm-in-cage assays, choice chamber assays, cloth patch testing, forced contact bioassays, Y-tube olfactometer or Y-maze olfactometer assays, laboratory and field bioassays, and modifications thereof. See, e.g., Fradin & Day, N Engl J Med. 2002 Jul. 4; 347(1):13-8 and Uniyal et al., J Arthropod Borne Dis. 2016 Jan. 6; 10(3):370-80.

Additionally, whether a substance, such as a disclosed composition, is toxic in the context of insecticidal and pesticidal applications may be assessed by evaluating a variety of effects, including ovicidal, larvicidal, pupicidal and adulticidal activity, assessments of which are available to one of skill in the art. In some examples, the toxicity of a disclosed composition may be assessed by determining the mortality of an insect upon contact or following contact with the disclosed composition. In the Examples section herein, insect mortality is assessed using a direct contact bioassay, which involves direct contact of an insect with a surface treated with a test substance. Free and forced direct contact bioassays are described by, e.g., Stell et al., J Med Entomol. 2013 July; 50(4):804-15 and Shin et al., Pest Manag Sci. 2011 June; 67(6):665-71.

In other examples, the toxicity of a disclosed composition may be assessed by evaluating growth inhibition, reproduction interference, or feeding inhibition of an insect upon contact or following contact with the disclosed composition. In additional examples, the toxicity of a disclosed composition may be evaluated by determining disruption a biological function of an insect contacted with the disclosed composition, such as disrupted hormonal activity, disrupted respiration, disrupted nervous system function, or a combination thereof, such as disruptive systemic effects.

### Botanical Compositions

In some aspects, provided herein are botanical compositions, such as botanical pesticide compositions. In some embodiments, disclosed botanical compositions comprise an herbal extract, a nut extract, a seed extract, a tree or shrub extract, or a combination thereof. In some embodiments, the extract is a decoction, an oil, such as a carrier oil or an essential oil, a hydrosol, an infusion, or a tincture.

In some embodiments, disclosed compositions consist essentially of botanical oil extracts, such as a mixture of at least one essential oil and carrier oil. Essential oils contain a variety of bioactive compounds, including terpenes, terpenoids, phenylpropanoids, and other constituents, extracted from various plant sources, e.g., bark, buds, flowers, fruits, leaves, peels, roots, seeds, twigs, or a whole plant. See, e.g., Masyita et al., Food Chem X. 2022 Mar. 30; 13:100217. Carrier oils are typically cold-pressed oils extracted from botanical fruits, nuts, and seeds.

### Herbal Extracts

In some embodiments, disclosed compositions comprise an herb extract. Herein, an “herb extract” may be referred to interchangeably as an “herbal extract.” The herbal extract may be extracted from the leaves, stem, flowers, and the like of an herb. In some embodiments, the herb, such as the source of the herbal extract, belongs to the plant family Lamiaceae (formerly Labiatae). In some embodiments, the herb is a member of the genus Hyssopus, Lavandula, Melissa, Mentha, Monarda, Nepeta, Ocimum, Origanum, Pogostemon, Salvia, or Thymus. In some embodiments, disclosed compositions comprise an herb selected from the group consisting of Hyssopus officinalis (hyssop), Mentha x piperita (peppermint), Mentha spicata (spearmint), Monarda spp., Nepeta cataria (catnip), Ocimum basilicum (basil), Origanum majorana (marjoram), Origanum vulgare (oregano), Pogostemon cablin (patchouli), Salvia officinalis (sage), Thymus vulgaris (thyme), and combinations thereof. In some embodiments, disclosed compositions comprise a combination of herbal extracts.

In some embodiments, disclosed compositions comprise at least one herbal extract, either singly or in combination, in a total % v/v amount of at least about 0.1%, 0.5%, 1%, 5%, 10%, 15%, or 20%, and less than 100%. In some embodiments, disclosed compositions comprise at least one herbal extract, either singly or in combination, in a total % v/v amount of about 5-10%, 5-15%, 5-20%, 5-25%, 5-30%, 5-35%, 5-45%, or 5-50%, inclusive. In some embodiments, disclosed compositions comprise at least one herbal extract, either singly or in combination, in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise at least one herbal extract, either singly or in combination, in a total % v/v amount of about 1-2%, 1-3%, 1-4%, 1-5%, 1-6%, 1-7%, 1-8%, 1-9%, or 1-10%, inclusive. In some embodiments, disclosed compositions comprise at least one herbal extract, either singly or in combination, in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the herbal extract is an herbal decoction, an herbal oil, such as an herbal carrier oil or an herbal essential oil, an herbal hydrosol, an herbal infusion, or an herbal tincture. In preferred embodiments, the herbal extract is an herbal essential oil.

In some embodiments, disclosed compositions comprise at least one Lamiaceae extract in a total % v/v amount of at least about 0.1%, 0.5%, 1%, 5%, 10%, 15%, or 20%, and less than 100%. In some embodiments, disclosed compositions comprise at least one Lamiaceae extract in a total % v/v amount of about 5-10%, 5-15%, 5-20%, 5-25%, 5-30%, 5-35%, 5-45%, or 5-50%, inclusive. In some embodiments, disclosed compositions comprise at least one Lamiaceae extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise at least one Lamiaceae extract in a total % v/v amount of about 1-2%, 1-3%, 1-4%, 1-5%, 1-6%, 1-7%, 1-8%, 1-9%, or 1-10%, inclusive. In some embodiments, disclosed compositions comprise at least one Lamiaceae extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Lamiaceae extract is a Lamiaceae decoction, a Lamiaceae oil, such as a Lamiaceae carrier oil or a Lamiaceae essential oil, a Lamiaceae hydrosol, a Lamiaceae infusion, or a Lamiaceae tincture. In preferred embodiments, the Lamiaceae extract is a Lamiaceae essential oil.

In some embodiments, disclosed compositions comprising a Lamiaceae extract comprise a Mentha extract. In some embodiments, the Mentha extract comprises menthol. In some embodiments, the Mentha extract comprises about 1-10%, 1-20%, 1-30%, 1-40%, 1-50%, 1-60%, 1-70%, 1-80%, 1-90%, or 1-100% menthol. In some embodiments, the Mentha extract comprises about 10-90%, 15-85%, 20-80%, 25-75%, 30-70%, 35-65%, 40-60%, or 45-55% menthol. In some embodiments, the Mentha extract comprises about 20-60%, 25-55%, 30-50%, or 35-45% menthol. In preferred embodiments, the Mentha extract is an oil, such as an essential oil. In additional preferred embodiments, the Mentha extract comprises peppermint essential oil.

In some embodiments, disclosed compositions comprise at least one mint oil, such as an essential oil. In some embodiments, the mint oil is extracted from Mentha suaveolens (apple mint), Mentha spicata (spearmint), Mentha requienii (Corsican mint), Mentha pulegium (pennyroyal), Mentha x piperita (peppermint), or a combination thereof. In preferred embodiments, the mint oil is extracted from the leaves of the mint plant. In some embodiments, the mint oil comprises a bioactive compound selected from the group consisting of α-terpinene, γ-terpinene, 1,8-cineole, menthone, mentho-furan, menthol, iso-menthol, neo-iso-menthol, pulegone, neo-menthyl acetate, piperitone, menthyl acetate, E-caryophyllene, germacrene D, and combinations thereof. In preferred embodiments, disclosed compositions comprise peppermint essential oil.

In some embodiments, disclosed compositions comprise the mint oil in a % v/v amount of at least about 0.1%, 0.5%, 1%, 5%, 10%, 15%, or 20% and less than 100%. In some embodiments, disclosed compositions comprise the mint oil in a % v/v amount of about 5-10%, 5-15%, 5-20%, 5-25%, 5-30%, 5-35%, 5-45%, or 5-50%, inclusive. In some embodiments, disclosed compositions comprise the mint oil in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise the mint oil in a % v/v amount of about 1-2%, 1-3%, 1-4%, 1-5%, 1-6%, 1-7%, 1-8%, 1-9%, or 1-10%, inclusive. In some embodiments, disclosed compositions comprise the mint oil in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

In some embodiments, disclosed compositions comprise peppermint oil in a % v/v amount of at least about 0.1%, 0.5%, 1%, 5%, 10%, 15%, or 20% and less than 100%. In some embodiments, disclosed compositions comprise a peppermint oil in a % v/v amount of about 5-10%, 5-15%, 5-20%, 5-25%, 5-30%, 5-35%, 5-45%, or 5-50%, inclusive. In some embodiments, disclosed compositions comprise peppermint oil in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise peppermint oil in a % v/v amount of about 1-2%, 1-3%, 1-4%, 1-5%, 1-6%, 1-7%, 1-8%, 1-9%, or 1-10%, inclusive. In some embodiments, disclosed compositions comprise peppermint oil in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

Peppermint (Mentha x piperita or Mentha piperita) is a hybrid of Mentha spicata (spearmint) and M. aquatica (watermint) belonging to the family Lamiaceae. Peppermint oil may be extracted from the flowering parts and leaves of the peppermint plant. In studying the chemical constituency of peppermint essential oil, Awad et al. found that the main volatile components were menthol (42.13%), menthone (22.82%), mentho-furan (11.79%), and 1,8-cineole (4.1%) (Awad et al., Life (Basel). 2022 November; 12 (11): 1751).

In some embodiments, disclosed compositions comprising a Lamiaceae extract comprise a Thymus extract. In some embodiments, the Thymus extract comprises thymol. In some embodiments, the Thymus extract comprises about 1-10%, 1-20%, 1-30%, 1-40%, 1-50%, 1-60%, 1-70%, 1-80%, 1-90%, or 1-100% thymol. In some embodiments, the Thymus extract comprises about 10-90%, 15-85%, 20-80%, 25-75%, 30-70%, 35-65%, 40-60%, or 45-55% thymol. In some embodiments, the Thymus extract comprises about 25-75%, 30-70%, 35-65%, 40-60%, or 45-55% thymol. In preferred embodiments, the Thymus extract is an oil, such as an essential oil. In additional preferred embodiments, the Thymus extract comprises thyme essential oil.

In some embodiments, disclosed compositions comprise thyme oil. In preferred embodiments, disclosed compositions comprise thyme oil, such as thyme essential oil, extracted from the leaves of the thyme plant. In some embodiments, the Thymus extract, such as thyme oil, comprises a bioactive compound selected from the group consisting of α-pinene, camphene, β-pinene, myrcene, α-terpinene, p-cymene, limonene, 1,8-cineole, γ-terpinene, terpinolene, linalool, borneol, terpinen-4-ol, α-terpineol, carvacrol methyl ether, linalyl acetate, thymol, carvacrol, longifolene, (e)-β-caryophyllene, α-humulene, caryophyllene oxide, and combinations thereof.

In some embodiments, disclosed compositions comprise thyme oil in a % v/v amount of at least about 0.1%, 0.5%, 1%, 5%, 10%, 15%, or 20%, and less than 100%. In some embodiments, disclosed compositions comprise a thyme oil in a % v/v amount of about 5-10%, 5-15%, 5-20%, 5-25%, 5-30%, 5-35%, 5-45%, or 5-50%, inclusive. In some embodiments, disclosed compositions comprise thyme oil in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise thyme oil in a % v/v amount of about 1-2%, 1-3%, 1-4%, 1-5%, 1-6%, 1-7%, 1-8%, 1-9%, or 1-10%, inclusive. In some embodiments, disclosed compositions comprise thyme oil in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

Commonly known as thyme, Thymus vulgaris is a flowering plant of the family Lamiaceae. Characterization of thyme oil, e.g., by GC/MS analysis, has revealed the presence of oxygenated monoterpenoids, e.g., thymol and carvacrol, linalool, borneol, and hydrocarbon monoterpenoids, e.g., p-cymene. See, e.g., Allahverdiyev et al., Chapter 17—Development of New Antiherpetic Drugs Based on Plant Compounds, Fighting Multidrug Resistance with Herbal Extracts, Essential Oils and Their Components, Academic Press, 2013, pages 245-259 and Mogoşanu et al. 11—Natural products used for food preservation, Nanotechnology in the Agri-Food Industry, Food Preservation, Academic Press, 2017, pages 365-411.

### Nut and Seed Extracts

In some embodiments, disclosed compositions comprise an extract from a nut or a seed. A seed is a mature fertilized ovule of a plant that has three parts, an embryo, an endosperm, and a seed coat. Nuts may be classified as fruit with a hard shell containing an edible kernel. However, a nut can also be classified as a seed, and most nuts are seeds. Some botanical seeds may be recognized by the layperson as nuts and referred to as such herein.

In some embodiments, disclosed compositions comprise an extract from a nut, such as a nut extract. In some embodiments, the nut, such as the source of the nut extract, belongs to the family Betulaceae, Fabaceae, Juglandaceae, or Rosaceae. In some embodiments, the nut belongs to the genus Arachis, Corylus, Juglans, or Prunus. In some embodiments, the nut extract is an almond extract, such as a Prunus dulcis extract, a hazelnut extract, such as a Corylus avellana extract, a peanut extract, such as an Arachis hypogaea extract, or a walnut extract, such as a Juglans regia extract.

In some embodiments, disclosed compositions comprise at least one nut extract, either singly or in combination, in a total % v/v amount of at least about 0.1%, 0.5%, 1%, 5%, 10%, 15%, or 20%, and less than 100%. In some embodiments, disclosed compositions comprise at least one nut extract, either singly or in combination, in a total % v/v amount of about 5-10%, 5-15%, 5-20%, 5-25%, 5-30%, 5-35%, 5-45%, or 5-50%, inclusive. In some embodiments, disclosed compositions comprise at least one nut extract, either singly or in combination, in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise at least one nut extract, either singly or in combination, in a total % v/v amount of about 1-2%, 1-3%, 1-4%, 1-5%, 1-6%, 1-7%, 1-8%, 1-9%, or 1-10%, inclusive. In some embodiments, disclosed compositions comprise at least one nut extract, either singly or in combination, in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

In some embodiments, the nut extract is a nut decoction, a nut oil, such as a nut carrier oil or a nut essential oil, a nut hydrosol, a nut infusion, or a nut tincture. In preferred embodiments, the nut extract is a nut essential oil.

In some embodiments, disclosed compositions comprise an extract from a seed, such as a seed extract. In some embodiments, the seed, such as the source of the seed extract, belongs to the family Apiaceae, Asteraceae, Brassicacaeae, Cannabaceae, Cucurbitaceae, Lamiaceae, Linaceae, Pedaliaceae, Piperaceae, or Ranunculaceae. In some embodiments, the seed belongs to the genus Brassica, Cannabis, Carum, Coriandrum, Cucurbita, Cuminum, Foeniculum, Gossypium, Helianthus, Linum, Malvaceae, Nigella, Piper, Salvia, or Sesamum. In some embodiments, the seed is Brassica napus (rapeseed), Cannabis sativa (hemp seed), Carum carvi (caraway seed), Coriandrum sativum (coriander seed), Cucurbita pepo, also referred to as Cucurbita maxima or Cucurbita moschata, (pumpkin seed), Cuminum cyminum (cumin seed), Foeniculum vulgare (fennel seed), Gossypium herbaceum (cottonseed), Gossypium hirsutum (cottonseed), Helianthus annuus (sunflower seed), Linum usitatissimum (flax seed), Nigella sativa (black cumin seed), Piper nigrum (black pepper seed), Salvia hispanica (chia seed), or Sesamum indicum (sesame seed).

In some embodiments, disclosed compositions comprise at least one seed extract in a total % v/v amount of at least about 0.1%, 0.5%, 1%, 5%, 10%, 15%, or 20%, and less than 100%. In some embodiments, disclosed compositions comprise at least one seed extract in a total % v/v amount of about 5-10%, 5-15%, 5-20%, 5-25%, 5-30%, 5-35%, 5-45%, or 5-50%, inclusive. In some embodiments, disclosed compositions comprise at least one seed extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise at least one seed extract in a total % v/v amount of about 1-2%, 1-3%, 1-4%, 1-5%, 1-6%, 1-7%, 1-8%, 1-9%, or 1- 10%. In some embodiments, disclosed compositions comprise at least one seed extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

In some embodiments, the seed extract is a seed decoction, a seed oil, such as a seed carrier oil or a seed essential oil, a seed hydrosol, a seed infusion, or a seed tincture. In preferred embodiments, the seed extract is a seed essential oil or a seed carrier oil.

In some embodiments, disclosed compositions comprise a Sesamum extract in a total % v/v amount of at least about 0.1%, 0.5%, 1%, 5%, 10%, 15%, or 20%, and less than 100%. In some embodiments, disclosed compositions comprise a Sesamum extract in a total % v/v amount of about 5-10%, 5-15%, 5-20%, 5-25%, 5-30%, 5-35%, 5-45%, or 5-50%, inclusive. In some embodiments, disclosed compositions comprise a Sesamum extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Sesamum extract in a total % v/v amount of about 1-2%, 1-3%, 1-4%, 1-5%, 1-6%, 1-7%, 1-8%, 1-9%, or 1-10%. In some embodiments, disclosed compositions comprise a Sesamum extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

In some embodiments, the Sesamum extract is a Sesamum decoction, a Sesamum oil, such as a Sesamum carrier oil or a Sesamum essential oil, a Sesamum hydrosol, a Sesamum infusion, or a Sesamum tincture. In preferred embodiments, the Sesamum extract is a Sesamum essential oil or a Sesamum carrier oil.

In some embodiments, the Sesamum extract comprises sesamolin. In some embodiments, the Sesamum extract comprises about 0.1-10%, 0.1-20%, 0.1-30%, 0.1-40%, 0.1-50%, 0.1-60%, 0.1-70%, 0.1-80%, 0.1-90%, or 0.1-100% sesamolin. In some embodiments, the Sesamum extract comprises about 0.1-1%, 0.1-2%, 0.1-3%, 0.1-4%, 0.1-5%, 0.1-6%, 0.1-7%, 0.1-8%, 0.1-9%, or 0.1-10% sesamolin. In some embodiments, the Sesamum extract comprises about 1-10%, 1-15%, 1-20%, 1-25-%, 1-30%, 1-35%, 1-40%, or 1-45% sesamolin. In some embodiments, the Sesamum extract comprises about 5-10%, 5-15%, 5-20%, 5-25-%, 5-30%, 5-35%, 5-40%, or 5-45% sesamolin. In preferred embodiments, the Sesamum extract is an oil, such as an essential oil. In additional preferred embodiments, the Sesamum extract comprises sesame essential oil, sesame carrier oil, or a combination thereof.

In some embodiments, disclosed compositions comprise sesame oil, such as sesame seed oil. In some embodiments, the Sesamum extract, such as sesame oil, comprises a bioactive compound selected from the group consisting of sesamol, sesamolin, sesamin, pinoresinol, and combinations thereof.

In some embodiments, disclosed compositions comprise sesame oil in a % v/v amount of at least about 0.1%, 0.5%, 1%, 5%, 10%, 15%, or 20%, and less than 100%. In some embodiments, disclosed compositions comprise sesame oil in a % v/v amount of about 5-10%, 5-15%, 5-20%, 5-25%, 5-30%, 5-35%, 5-45%, or 5-50%. In some embodiments, disclosed compositions comprise sesame oil in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%. In some embodiments, disclosed compositions comprise sesame oil in a % v/v amount of about 1-2%, 1-3%, 1-4%, 1-5%, 1-6%, 1-7%, 1-8%, 1-9%, or 1-10%. In some embodiments, disclosed compositions comprise sesame oil in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

Sesame seed oil (Sesamum indicum), referred to interchangeably herein as “sesame oil,” is an edible vegetable oil derived from the oilseed crop sesame seed. The major lignans of sesame seed, sesamin and sesamolin, are benzodioxol-substituted furofurans, which have been identified as synergists of pyrethrins, a class of organic compounds with potent insecticidal activity typically derived from Chrysanthemum cinerariifolium See, e.g., U.S. Pat. No. 2,837,534A; and Andargie et al., Molecules. 2021 February; 26 (4): 883). Sesame seed oil has also been found to enhance the insecticidal activity of other botanical essential oils. See, e.g, Soe et al., Kaen Kaset=Khon Kaen Agriculture Journal 2019 Vol. 47 No. Suppl. 1 pp. 351-356 ref. 16 and Mesbah et al., Commun Agric Appl Biol Sci. 2006; 71 (2 Pt B): 305-28. Sesame seed oil may also be used as a horticultural oil, as described herein, for its smotherant properties.

### Tree or Shrub Extracts

In some embodiments, disclosed compositions comprise a tree or shrub extract, such as an extract of any one or more of the bark, needles, leaves, fruits, and berries of a tree or a shrub. In some embodiments, the tree or the shrub, such as the source of the tree or shrub extract, belongs to the family Arecaceae, Cupressaceae, Geraniaceae, Lamiaceae, Meliaceae, Pinaceae, Poaceae, or Santalaceae. In some embodiments, the tree or the shrub belongs to the genus Abies, Azadirachta, Cedrus, Cocos, Cupressaceae, Cymbopogon, Elaeis, Geranium, Larix, Myrtaceae, Pelargonium, Picea, Pinus, Rosmarinus, Santalaceae, Syzgium, or Tsuga. In some embodiments, the tree or the shrub is Abies grandis, Abies concolor, Abies lasiocarpa, Azadirachta indica, Cedrus atlantica, Cedrus brvifolia, Cedrus deodara, Cedrus libani, Cocos nucifera, Cupressus sempervirens, Elaeis guineensis, Elaeis oleifera, Eucalyptus globulus, Eucalyptus radiata, Juniperus ashei, Juniperus virginiana, Larix decidua, Larix laricina, Pelargonium asperum, Pelargonium capitatum, Pelargonium graveolens, Picea mariana, Picea omorika, Picea pungens Pinus pinaster, Pinus radiata, Pinus strobus, Rosmarinus officinalis, Santalum album, Santalum spicatum, Syzygium aromaticum, Tsuga canadensis, Tsuga heterophylla. In some embodiments, disclosed compositions comprise a combination of tree or shrub extracts.

In some embodiments, disclosed compositions comprise at least one tree or shrub extract, either singly or in combination, in a total % v/v amount of at least about 0.1%, 0.5%, 1%, 5%, 10%, 15%, or 20%, and less than 100%. In some embodiments, disclosed compositions comprise at least one tree or shrub extract, either singly or in combination, in a total % v/v amount of about 5-10%, 5-15%, 5-20%, 5-25%, 5-30%, 5-35%, 5-45%, or 5-50%, inclusive. In some embodiments, disclosed compositions comprise at least one tree or shrub extract, either singly or in combination, in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise at least one tree or shrub extract, either singly or in combination, in a total % v/v amount of about 1-2%, 1-3%, 1-4%, 1-5%, 1-6%, 1-7%, 1-8%, 1-9%, or 1-10%. In some embodiments, disclosed compositions comprise at least one tree or shrub extract, either singly or in combination, in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

In some embodiments, the tree or shrub extract is a tree or shrub decoction, a tree or shrub oil, such as a tree or shrub carrier oil or a tree or shrub essential oil, a tree or shrub hydrosol, a tree or shrub infusion, or a tree or shrub tincture. In preferred embodiments, the tree or shrub extract is a tree or shrub essential oil.

In some embodiments, disclosed compositions comprise a Pinaceae extract in a total % v/v amount of at least about 0.1%, 0.5%, 1%, 5%, 10%, 15%, or 20%, and less than 100%. In some embodiments, disclosed compositions comprise a Pinaceae extract in a total % v/v amount of about 5-10%, 5-15%, 5-20%, 5-25%, 5-30%, 5-35%, 5-45%, or 5-50%, inclusive. In some embodiments, disclosed compositions comprise a Pinaceae extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Pinaceae extract in a total % v/v amount of about 1-2%, 1-3%, 1-4%, 1-5%, 1-6%, 1-7%, 1-8%, 1-9%, or 1-10%, inclusive. In some embodiments, disclosed compositions comprise a Pinaceae extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Pinaceae extract is a Pinaceae decoction, a Pinaceae oil, such as a Pinaceae carrier oil or a Pinaceae essential oil, a Pinaceae hydrosol, a Pinaceae infusion, or a Pinaceae tincture. In preferred embodiments, the tree or shrub extract is a Pinaceae essential oil. In additional preferred embodiments, the Pinaceae oil extract, such as an essential oil, is derived from the wood of the plant.

In some embodiments, disclosed compositions comprise a Cedrus extract in a total % v/v amount of at least about 0.1%, 0.5%, 1%, 5%, 10%, 15%, or 20%, and less than 100%. In some embodiments, disclosed compositions comprise a Cedrus extract in a total % v/v amount of about 5-10%, 5-15%, 5-20%, 5-25%, 5-30%, 5-35%, 5-45%, or 5-50%, inclusive. In some embodiments, disclosed compositions comprise a Cedrus extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Cedrus extract in a total % v/v amount of about 1-2%, 1-3%, 1-4%, 1-5%, 1-6%, 1-7%, 1-8%, 1-9%, or 1-10%, inclusive. In some embodiments, disclosed compositions comprise a Cedrus extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Cedrus extract is a Cedrus decoction, a Cedrus oil, such as a Cedrus carrier oil or a Cedrus essential oil, a Cedrus hydrosol, a Cedrus infusion, or a Cedrus tincture. In preferred embodiments, the herbal extract is a Cedrus essential oil.

In some embodiments, disclosed compositions comprising a Pinaceae extract comprise a Cedrus extract. In some embodiments, the Cedrus extract comprises alpha-cedrene. In some embodiments, the Cedrus extract comprises about 1-10%, 1-20%, 1-30%, 1-40%, 1-50%, 1-60%, 1-70%, 1-80%, 1-90%, or 1-100% alpha-cedrene. In some embodiments, the Cedrus extract comprises about 5-90%, 10-85%, 15-80%, 20-75%, 25-70%, 30-65%, 35-60%, or 40-55% alpha-cedrene. In some embodiments, the Cedrus extract comprises about 10-50%, 15-45%, 20-40%, or 30-35% alpha-cedrene. In preferred embodiments, the Cedrus extract is an oil, such as an essential oil. In additional preferred embodiments, the Cedrus extract comprises cedar essential oil.

In some embodiments, disclosed compositions comprise cedar oil, such as cedar essential oil. In some embodiments, the cedar oil comprises a bioactive compound selected from the group consisting of cedr-9-en, 7-epi-α-Cedrene, α-cedrene, β-cedrene, thujopsene, ar-curcumene, cis-β-guaiene, α-cuprenene, cuparene, trans-calamenene, γ-cuprenene, cedrol, 12-epi-cedrol, γ-eudesmol, α-cadinol, α-eudesmol, β-bisabolol, 1H-benzocycloheptene, 2,4a,5,6,7,8-hexahydro-3,5,5,9-tetramethyl-(R) (5.01%), and (+)-cuparene, and combinations thereof.

In some embodiments, disclosed compositions comprise cedar oil in a % v/v amount of at least about 0.1%, 0.5%, 1%, 5%, 10%, 15%, or 20%, and less than 100%. In some embodiments, disclosed compositions comprise a cedar oil in a % v/v amount of about 5-10%, 5-15%, 5-20%, 5-25%, 5-30%, 5-35%, 5-45%, or 5-50%, inclusive. In some embodiments, disclosed compositions comprise cedar oil in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise cedar oil in a % v/v amount of about 1-2%, 1-3%, 1-4%, 1-5%, 1-6%, 1-7%, 1-8%, 1-9%, or 1-10%, inclusive. In some embodiments, disclosed compositions comprise cedar oil in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

Cedrus deodara belonging to the family of Pinaceae, contains rich essential oil in its flowers, leaves, stems and roots. Cedar essential oil can be extracted by steam distillation, extrusion, cold leaching, and solvent extraction from the needles, leaves, bark, and berries of cedar trees. The chemical constituents and properties have been described, e.g., by Huang et al., Food Chemistry 2021; 346:128970.

In some embodiments, disclosed compositions comprise a Cupressaceae extract in a total % v/v amount of at least about 0.1%, 0.5%, 1%, 5%, 10%, 15%, or 20%, and less than 100%. In some embodiments, disclosed compositions comprise a Cupressaceae extract in a total % v/v amount of about 5-10%, 5-15%, 5-20%, 5-25%, 5-30%, 5-35%, 5-45%, or 5-50%, inclusive. In some embodiments, disclosed compositions comprise a Cupressaceae extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Cupressaceae extract in a total % v/v amount of about 1-2%, 1-3%, 1-4%, 1-5%, 1-6%, 1-7%, 1-8%, 1-9%, or 1- 10%, inclusive. In some embodiments, disclosed compositions comprise a Cupressaceae extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Cupressaceae extract is a Cupressaceae decoction, a Cupressaceae oil, such as a Cupressaceae carrier oil or a Cupressaceae essential oil, a Cupressaceae hydrosol, a Cupressaceae infusion, or a Cupressaceae tincture. In preferred embodiments, the tree or shrub extract is a Cupressaceae essential oil. In additional preferred embodiments, the Cupressaceae oil extract, such as an essential oil, is derived from the wood of the plant.

In some embodiments, disclosed compositions comprise a Juniperus extract in a total % v/v amount of at least about 0.1%, 0.5%, 1%, 5%, 10%, 15%, or 20%, and less than 100%. In some embodiments, disclosed compositions comprise a Juniperus extract in a total % v/v amount of about 5-10%, 5-15%, 5-20%, 5-25%, 5-30%, 5-35%, 5-45%, or 5-50%, inclusive. In some embodiments, disclosed compositions comprise a Juniperus extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Juniperus extract in a total % v/v amount of about 1-2%, 1-3%, 1-4%, 1-5%, 1-6%, 1-7%, 1-8%, 1-9%, or 1-10%, inclusive. In some embodiments, disclosed compositions comprise a Juniperus extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Juniperus extract is a Juniperus decoction, a Juniperus oil, such as a Juniperus carrier oil or a Juniperus essential oil, a Juniperus hydrosol, a Juniperus infusion, or a Juniperus tincture. In preferred embodiments, the herbal extract is a Juniperus essential oil.

In some embodiments, disclosed compositions comprising a Cupressaceae extract comprise a Juniperus extract. In some embodiments, the Juniperus extract comprises alpha-cedrene. In some embodiments, the Juniperus extract comprises about 1-10%, 1-20%, 1-30%, 1-40%, 1-50%, 1-60%, 1-70%, 1-80%, 1-90%, or 1-100% alpha-cedrene. In some embodiments, the Juniperus extract comprises about 5-90%, 10-85%, 15-80%, 20-75%, 25-70%, 30-65%, 35-60%, or 40-55% alpha-cedrene. In some embodiments, the Juniperus extract comprises about 10-50%, 15-45%, 20-40%, or 30-35% alpha-cedrene. In preferred embodiments, the Juniperus extract is an oil, such as an essential oil. In additional preferred embodiments, the Juniperus extract comprises cedarwood essential oil.

In some embodiments, disclosed compositions comprise cedarwood oil, such as cedarwood essential oil. In some embodiments, the cedarwood oil comprises a bioactive compound selected from the group consisting of cedr-9-en, 7-epi-α-cedrene, α-cedrene, β-cedrene, thujopsene, α-copaene, methyl thujate, thujic acid, α-thujaplicin, β-thujaplicin cedrol, (+)-cuparene, widdrol, and combinations thereof.

In some embodiments, disclosed compositions comprise cedarwood oil in a % v/v amount of at least about 0.1%, 0.5%, 1%, 5%, 10%, 15%, or 20%, and less than 100%. In some embodiments, disclosed compositions comprise a cedarwood oil in a % v/v amount of about 5-10%, 5-15%, 5-20%, 5-25%, 5-30%, 5-35%, 5-45%, or 5-50%, inclusive. In some embodiments, disclosed compositions comprise cedarwood oil in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise cedarwood oil in a % v/v amount of about 1-2%, 1-3%, 1-4%, 1-5%, 1-6%, 1-7%, 1-8%, 1-9%, or 1-10%, inclusive. In some embodiments, disclosed compositions comprise cedarwood oil in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

Cedar oil derived from the wood of a cedar tree may also be recognized as cedarwood oil. However, herein, the term “cedarwood” refers to juniper trees, e.g., Juniperus mexicana and Juniperus virginiana, which are part of the cypress family (Cupressaceae). Disclosed compositions comprising cedar oil or cedarwood oil can be differentiated based on specification of the distinct botanical source, such as a Cedrus extract, a Juniperus extract, or a mixture of Cedrus and Juniperus extracts. Worthy of note, the chemical constituent α-cedrene is common amongst certain Cedrus and Juniperus extracts.

Species of Juniperus are coniferous evergreens belonging to the family Cupressaceae. Cedarwood essential oil can be extracted by steam distillation, extrusion, cold leaching, and solvent extraction from the needles, leaves, bark of cedarwood trees. In preferred examples, the cedarwood oil is derived from the wood of a cedarwood tree, e.g., Juniperus mexicana and Juniperus virginiana. The chemical constituents and properties of cedarwood oil extracts have been described, e.g., by NTP Technical Report on the Toxicity Studies of Cedarwood Oil (Virginia) (CASRN 8000-27-9) Administered Dermally to F344/N Rats and B6C3F1/N Mice: Toxicity Report 86 [Internet]; Kamatou et al., South African Journal of Botany, 2010; 76 (4): 652-654; NTEP, Summary of Data for Chemical Selection, Cedarwood Oil 8000-27-9 retrieved from https://ntp.niehs.nih.gov/sites/default/files/ntp/htdocs/chem_background/exsumpdf/cedarwood_oil_508.pdf.

In some embodiments, disclosed compositions comprise a Myrtaceae extract in a total % v/v amount of at least about 0.1%, 0.5%, 1%, 5%, 10%, 15%, or 20%, and less than 100%. In some embodiments, disclosed compositions comprise a Myrtaceae extract in a total % v/v amount of about 5-10%, 5-15%, 5-20%, 5-25%, 5-30%, 5-35%, 5-45%, or 5-50%, inclusive. In some embodiments, disclosed compositions comprise a Myrtaceae extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Myrtaceae extract in a total % v/v amount of about 1-2%, 1-3%, 1-4%, 1-5%, 1-6%, 1-7%, 1-8%, 1-9%, or 1-10%, inclusive. In some embodiments, disclosed compositions comprise a Myrtaceae extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Myrtaceae extract is a Myrtaceae decoction, a Myrtaceae oil, such as a Myrtaceae carrier oil or a Myrtaceae essential oil, a Myrtaceae hydrosol, a Myrtaceae infusion, or a Myrtaceae tincture. In preferred embodiments, the herbal extract is a Myrtaceae essential oil.

In some embodiments, disclosed compositions comprise a Syzgium extract in a total % v/v amount of at least about 0.1%, 0.5%, 1%, 5%, 10%, 15%, or 20%, and less than 100%. In some embodiments, disclosed compositions comprise a Syzgium extract in a total % v/v amount of about 5-10%, 5-15%, 5-20%, 5-25%, 5-30%, 5-35%, 5-45%, or 5-50%, inclusive. In some embodiments, disclosed compositions comprise a Syzgium extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Syzgium extract in a total % v/v amount of about 1-2%, 1-3%, 1-4%, 1-5%, 1-6%, 1-7%, 1-8%, 1-9%, or 1-10%, inclusive. In some embodiments, disclosed compositions comprise a Syzgium extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Syzgium extract is a Syzgium decoction, a Syzgium oil, such as a Syzgium carrier oil or a Syzgium essential oil, a Syzgium hydrosol, a Syzgium infusion, or a Syzgium tincture. In preferred embodiments, the herbal extract is a Syzgium essential oil.

In some embodiments, disclosed compositions comprising a Myrtaceae extract comprise a Syzgium extract. In some embodiments, the Syzgium extract comprises eugenol. In some embodiments, the Syzgium extract comprises about 1-10%, 1-20%, 1-30%, 1-40%, 1-50%, 1-60%, 1-70%, 1-80%, 1-90%, or 1-100% eugenol. In some embodiments, the Syzgium extract comprises about 10-95%, 15-90%, 20-80%, 25-75%, 30-70%, 35-65%, 40-60%, or 45-55% eugenol. In preferred embodiments, the Syzgium extract is an oil, such as an essential oil. In additional preferred embodiments, the Syzgium extract comprises clove essential oil.

In some embodiments, disclosed compositions comprise clove oil. In preferred embodiments, the clove oil, such as clove essential oil, is extracted from the bud and/or the leaf of the clove plant, e.g., Syzgium aromaticum. In some embodiments, the clove oil comprises a bioactive compound selected from the group consisting of eugenol, isoeugenol, caryophyllene, humulene, α-amorphene, acetyleugenol, and combinations thereof.

In some embodiments, disclosed compositions comprise clove oil in a % v/v amount of at least about 0.1%, 0.5%, 1%, 5%, 10%, 15%, or 20%, and less than 100%. In some embodiments, disclosed compositions comprise clove oil in a % v/v amount of about 5-10%, 5-15%, 5-20%, 5-25%, 5-30%, 5-35%, 5-45%, or 5-50%, inclusive. In some embodiments, disclosed compositions comprise clove oil in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%. In some embodiments, disclosed compositions comprise clove oil in a % v/v amount of about 1-2%, 1-3%, 1-4%, 1-5%, 1-6%, 1-7%, 1-8%, 1-9%, or 1-10%, inclusive. In some embodiments, disclosed compositions comprise clove oil in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

The chemical constituents of clove oil have been analyzed by, e.g., Awad et al., Life (Basel). 2022 November; 12 (11): 1751. In a study evaluating the toxicity of essential oils against the two spotted spider mite (TSSM), Tetranychus urticae, which rapidly reproduces and can develop resistance to chemical pesticides, Awad et al. found that clove oil was most toxic. Notably, basil and peppermint essential oils were the least effective in terms of acaricidal activity.

In some embodiments, disclosed compositions comprise a Lamiaceae extract in a total % v/v amount of at least about 0.1%, 0.5%, 1%, 5%, 10%, 15%, or 20%, and less than 100%. In some embodiments, disclosed compositions comprise a Lamiaceae extract in a total % v/v amount of about 5-10%, 5-15%, 5-20%, 5-25%, 5-30%, 5-35%, 5-45%, or 5-50%, inclusive. In some embodiments, disclosed compositions comprise a Lamiaceae extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Lamiaceae extract in a total % v/v amount of about 1-2%, 1-3%, 1-4%, 1-5%, 1-6%, 1-7%, 1-8%, 1-9%, or 1-10%, inclusive. In some embodiments, disclosed compositions comprise a Lamiaceae extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Lamiaceae extract is a Lamiaceae decoction, a Lamiaceae oil, such as a Lamiaceae carrier oil or a Lamiaceae essential oil, a Lamiaceae hydrosol, a Lamiaceae infusion, or a Lamiaceae tincture. In preferred embodiments, the herbal extract is a Lamiaceae essential oil.

In some embodiments, disclosed compositions comprise a Rosmarinus extract in a total % v/v amount of at least about 0.1%, 0.5%, 1%, 5%, 10%, 15%, or 20%, and less than 100%. In some embodiments, disclosed compositions comprise a Rosmarinus extract in a total % v/v amount of about 5-10%, 5-15%, 5-20%, 5-25%, 5-30%, 5-35%, 5-45%, or 5-50%, inclusive. In some embodiments, disclosed compositions comprise a Rosmarinus extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Rosmarinus extract in a total % v/v amount of about 1-2%, 1-3%, 1-4%, 1-5%, 1-6%, 1-7%, 1-8%, 1-9%, or 1-10%, inclusive. In some embodiments, disclosed compositions comprise a Rosmarinus extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Rosmarinus extract is a Rosmarinus decoction, a Rosmarinus oil, such as a Rosmarinus carrier oil or a Rosmarinus essential oil, a Rosmarinus hydrosol, a Rosmarinus infusion, or a Rosmarinus tincture. In preferred embodiments, the herbal extract is a Rosmarinus essential oil.

In some embodiments, disclosed compositions comprising a Lamiaceae extract comprise a Rosmarinus extract. In some embodiments, the Rosmarinus extract comprises 1,8-cineole, which is also known as eucalyptol. In some embodiments, the Rosmarinus extract comprises about 1-10%, 1-20%, 1-30%, 1-40%, 1-50%, 1-60%, 1-70%, 1-80%, 1-90%, or 1-100% 1,8-cineole. In some embodiments, the Rosmarinus extract comprises about 10-95%, 15-90%, 20-80%, 25-75%, 30-70%, 35-65%, 40-60%, or 45-55% 1,8-cineole. In preferred embodiments, the Rosmarinus extract is an oil, such as an essential oil. In additional preferred embodiments, the Rosmarinus extract comprises rosemary essential oil.

In some embodiments, disclosed compositions comprise rosemary oil. In preferred embodiments, the rosemary oil, such as rosemary essential oil, is extracted from the leaf of the shrub, e.g., Rosmarinus officinalis. In some embodiments, the rosemary oil comprises a bioactive compound selected from the group consisting of 1,8-cineole (eucalyptol), α-pinene, camphene, β-pinene, β-myrcene, α-phellandrene, limonene, γ-terpinene, 1,8-cineole, linalool, (+)-camphor, isoborneol, borneol, α-terpineol, verbenone, β-caryophyllene, β-farnesene, γ-muurolene, caryophyllene oxide, tricyclene, 3-octanone, carnosol, carnosic acid, ursolic acid, rosmarinic acid, genkwanin, luteolin-7-O-glucoside, homoplantaginin, epigallocatechin, quinic acid, syringic acid, neohesperidin, and combinations thereof.

In some embodiments, disclosed compositions comprise rosemary oil in a % v/v amount of at least about 0.1%, 0.5%, 1%, 5%, 10%, 15%, or 20%, and less than 100%. In some embodiments, disclosed compositions comprise rosemary oil in a % v/v amount of about 5-10%, 5-15%, 5-20%, 5-25%, 5-30%, 5-35%, 5-45%, or 5-50%, inclusive. In some embodiments, disclosed compositions comprise rosemary oil in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%. In some embodiments, disclosed compositions comprise rosemary oil in a % v/v amount of about 1-2%, 1-3%, 1-4%, 1-5%, 1-6%, 1-7%, 1-8%, 1-9%, or 1-10%, inclusive. In some embodiments, disclosed compositions comprise rosemary oil in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

Rosemary is a perennial evergreen herb with fragrant needle-like leaves. The various varieties of rosemary are described, e.g., by Begum et al., Acta Sci. Pol., Technol. Aliment. 12 (1) 2013, 61-73. Rosemary extracts contain several bioactive compounds, which have been analyzed, e.g., by Borrás-Linares et al., Int. J. Mol. Sci. 2014, 15 (11): 20585-20606 and Hussain et al., Braz J Microbiol. 2010 October-December; 41 (4): 1070-1078.

In some embodiments, disclosed compositions comprise a Geraniaceae extract in a total % v/v amount of at least about 0.1%, 0.5%, 1%, 5%, 10%, 15%, or 20%, and less than 100%. In some embodiments, disclosed compositions comprise a Geraniaceae extract in a total % v/v amount of about 5-10%, 5-15%, 5-20%, 5-25%, 5-30%, 5-35%, 5-45%, or 5-50%, inclusive. In some embodiments, disclosed compositions comprise a Geraniaceae extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Geraniaceae extract in a total % v/v amount of about 1-2%, 1-3%, 1-4%, 1-5%, 1-6%, 1-7%, 1-8%, 1-9%, or 1- 10%, inclusive. In some embodiments, disclosed compositions comprise a Geraniaceae extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Geraniaceae extract is a Geraniaceae decoction, a Geraniaceae oil, such as a Geraniaceae carrier oil or a Geraniaceae essential oil, a Geraniaceae hydrosol, a Geraniaceae infusion, or a Geraniaceae tincture. In preferred embodiments, the herbal extract is a Geraniaceae essential oil.

In some embodiments, disclosed compositions comprise a Pelargonium extract in a total % v/v amount of at least about 0.1%, 0.5%, 1%, 5%, 10%, 15%, or 20%, and less than 100%. In some embodiments, disclosed compositions comprise a Pelargonium extract in a total % v/v amount of about 5-10%, 5-15%, 5-20%, 5-25%, 5-30%, 5-35%, 5-45%, or 5-50%, inclusive. In some embodiments, disclosed compositions comprise a Pelargonium extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Pelargonium extract in a total % v/v amount of about 1-2%, 1-3%, 1-4%, 1-5%, 1-6%, 1-7%, 1-8%, 1-9%, or 1- 10%, inclusive. In some embodiments, disclosed compositions comprise a Pelargonium extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Pelargonium extract is a Pelargonium decoction, a Pelargonium oil, such as a Pelargonium carrier oil or a Pelargonium essential oil, a Pelargonium hydrosol, a Pelargonium infusion, or a Pelargonium tincture. In preferred embodiments, the herbal extract is a Pelargonium essential oil.

In some embodiments, disclosed compositions comprising a Pelargonium extract. In some embodiments, the Pelargonium extract comprises geraniol. In some embodiments, the Pelargonium extract comprises about 1-10%, 1-20%, 1-30%, 1-40%, 1-50%, 1-60%, 1-70%, 1-80%, 1-90%, or 1-100% geraniol. In some embodiments, the Pelargonium extract comprises about 10-95%, 15-90%, 20-80%, 25-75%, 30-70%, 35-65%, 40-60%, or 45-55% geraniol. In preferred embodiments, the Pelargonium extract is an oil, such as an essential oil. In additional preferred embodiments, the Pelargonium extract comprises geranium essential oil.

In some embodiments, disclosed compositions comprise geranium oil. In preferred embodiments, the geranium oil, such as geranium essential oil, is extracted from the leaves, stem, petioles, or flowers of the shrub, or a combination thereof, e.g., from Pelargonium asperum, Pelargonium capitatum, or Pelargonium graveolens. In some embodiments, the geranium oil comprises a bioactive compound selected from the group consisting of α-pinene, linalool, cis-rose oxide, trans-rose oxide, menthone, citronellol, geraniol, citronellyl formate, geranyl formate, citronellyl acetate, α-copaene, geranyl acetate, guaiadiene, caryophellene, citronellyl propanoate, α-agarofuran, geranyl n-butyrate, phenylethyl tiglate, 10-epi-gamma-eudesmol, citronellyl tiglate, geranyl tiglate, myrcene, α-phellandrene, limonene, 1,8-cineol, β-phellandrene, γ-terpinene, p-cymene, terpinolene, cis-rose oxide, trans-rose oxide, trans-linalool oxide (furanoid), isomenthone, α-bourbonene, β-bourbonene, α-guaiene, β-caryophyllene, 6,9-guaidiene, menthol, aromadendrene, alloaromadendrene, epi-zonarene, α-humulene, α-terpineol, geranyl formate, ledene, germacrene, citronellyl propionate, α-muurolene, bicyclogermacrene, δ-cadinene, γ-cadinene, nerol, citronellyl butyrate, calamelene, myrtanol, geranyl butyrate, citronellyl, 4-methyl valerate, 1,10-di-epi-cubenol, and combinations thereof.

In some embodiments, disclosed compositions comprise geranium oil in a % v/v amount of at least about 0.1%, 0.5%, 1%, 5%, 10%, 15%, or 20%, and less than 100%. In some embodiments, disclosed compositions comprise geranium oil in a % v/v amount of about 5-10%, 5-15%, 5-20%, 5-25%, 5-30%, 5-35%, 5-45%, or 5-50%, inclusive. In some embodiments, disclosed compositions comprise geranium oil in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%. In some embodiments, disclosed compositions comprise geranium oil in a % v/v amount of about 1-2%, 1-3%, 1-4%, 1-5%, 1-6%, 1-7%, 1-8%, 1-9%, or 1-10%, inclusive. In some embodiments, disclosed compositions comprise geranium oil in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

In some embodiments, disclosed compositions comprise a Poaceae extract in a total % v/v amount of at least about 0.1%, 0.5%, 1%, 5%, 10%, 15%, or 20%, and less than 100%. In some embodiments, disclosed compositions comprise a Poaceae extract in a total % v/v amount of about 5-10%, 5-15%, 5-20%, 5-25%, 5-30%, 5-35%, 5-45%, or 5-50%, inclusive. In some embodiments, disclosed compositions comprise a Poaceae extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Poaceae extract in a total % v/v amount of about 1-2%, 1-3%, 1-4%, 1-5%, 1-6%, 1-7%, 1-8%, 1-9%, or 1-10%, inclusive. In some embodiments, disclosed compositions comprise a Poaceae extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Poaceae extract is a Poaceae decoction, a Poaceae oil, such as a Poaceae carrier oil or a Poaceae essential oil, a Poaceae hydrosol, a Poaceae infusion, or a Poaceae tincture. In preferred embodiments, the herbal extract is a Poaceae essential oil.

In some embodiments, disclosed compositions comprise a Cymbopogon extract in a total % v/v amount of at least about 0.1%, 0.5%, 1%, 5%, 10%, 15%, or 20%, and less than 100%. In some embodiments, disclosed compositions comprise a Cymbopogon extract in a total % v/v amount of about 5-10%, 5-15%, 5-20%, 5-25%, 5-30%, 5-35%, 5-45%, or 5-50%, inclusive. In some embodiments, disclosed compositions comprise a Cymbopogon extract in a total % v/v amount of about 0.1-1%, 0.1-2%, 0.1-3%, 0.1-4%, 0.1-5%, 0.1-6%, 0.1-7%, 0.1-8%, 0.1-9%, or 0.1-10%, inclusive. In some embodiments, disclosed compositions comprise a Cymbopogon extract in a total % v/v amount of about 1-2%, 1-3%, 1-4%, 1-5%, 1-6%, 1-7%, 1-8%, 1-9%, or 1- 10%, inclusive. In some embodiments, disclosed compositions comprise a Cymbopogon extract in a total % v/v amount of about 1%, 2%, 3%, 4%, 5%, 6%, 7%, 8%, 9%, 10%, 11%, 12%, 13%, 14%, 15%, 16%, 17%, 18%, 19%, or 20%, inclusive.

In some embodiments, the Cymbopogon extract is a Cymbopogon decoction, a Cymbopogon oil, such as a Cymbopogon carrier oil or a Cymbopogon essential oil, a Cymbopogon hydrosol, a Cymbopogon infusion, or a Cymbopogon tincture. In preferred embodiments, the herbal extract is a Cymbopogon essential oil.

In some embodiments, disclosed compositions comprising a Cymbopogon extract. In some embodiments, the Cymbopogon extract comprises geraniol. In some embodiments, the Cymbopogon extract comprises about 1-10%, 1-20%, 1-30%, 1-40%, 1-50%, 1-60%, 1-70%, 1-80%, 1-90%, or 1-100% geraniol. In some embodiments, the Cymbopogon extract comprises about 10-95%, 15-90%, 20-80%, 25-75%, 30-70%, 35-65%, 40-60%, or 45-55% geraniol. In preferred embodiments, the Cymbopogon extract is an oil, such as an essential oil. In additional preferred embodiments, the Cymbopogon extract comprises geraniol.

In some embodiments, disclosed compositions comprise citronella oil. In preferred embodiments, the citronella oil, such as citronella essential oil, is extracted from the leaves and/or stem of the perennial, e.g., from Cymbopogon nardus. In some embodiments, the citronella oil comprises a bioactive compound selected from the group consisting of citronellal, citronellol, geraniol, 4-elemene, germacene-d, elemol, germacredien-5-ol, eugenol, elemol, α-amorfene, β-selinene, 16-eudesml, α-selinene, α-eudesmol, and α-muuorele.

In some embodiments, disclosed compositions comprise citronella oil in a % v/v amount of at least about 0.1%, 0.5%, 1%, 5%, 10%, 15%, or 20%, and less than 100%. In some embodiments, disclosed compositions comprise citronella oil in a % v/v amount of about 5-10%, 5-15%, 5-20%, 5-25%, 5-30%, 5-35%, 5-45%, or 5-50%, inclusive. In some embodiments, disclosed compositions comprise citronella oil in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%. In some embodiments, disclosed compositions comprise citronella oil in a % v/v amount of about 1-2%, 1-3%, 1-4%, 1-5%, 1-6%, 1-7%, 1-8%, 1-9%, or 1-10%, inclusive. In some embodiments, disclosed compositions comprise citronella oil in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

In some embodiments, disclosed compositions comprise geraniol in a % v/v amount of at least about 0.1%, 0.5%, 1%, 5%, 10%, 15%, or 20%, and less than 100%. In some embodiments, disclosed compositions comprise geraniol in a % v/v amount of about 1-10%, 5-10%, 5-15%, 5-20%, 5-25%, 5-30%, 5-35%, 5-45%, or 5-50%, inclusive. In some embodiments, disclosed compositions comprise geraniol in a % v/v amount of about 0.1-1%, 0.1-2%, 0.1-3%, 0.1-4%, 0.1-5%, 0.1-6%, 0.1-7%, 0.1-8%, 0.1-9%, or 0.1-10%. In some embodiments, disclosed compositions comprise geraniol in a % v/v amount of about 1-2%, 1-3%, 1-4%, 1-5%, 1-6%, 1-7%, 1-8%, 1-9%, or 1-10%, inclusive. In some embodiments, disclosed compositions comprise geraniol in a % v/v amount of about 1%, 2%, 3%, 4%, 5%, 6%, 7%, 8%, 9%, 10%, 11%, 12%, 13%, 14%, 15%, 16%, 17%, 18%, 19%, or 20%.

Citronella oil is an essential oil obtained from the leaves and stems of different species of Cymbopogon (lemongrass). See, e.g., Sharma et al., Curr Drug Discov Technol. 2019; 16(4):330-339. Pelargonium oil extracts can be obtained from the leaves, stems, petioles, and flowers of the plant. The chemical components of geranium oil have been determined, e.g, by Dos Santos Niculau et al., Molecules. 2020 Oct. 24; 25(21):4923 and Dumlupinar et al., Plants (Basel). 2023 September; 12(17):3080, revealing citronellol and geraniol as major components. In some examples, isolated geraniol is included in disclosed compositions. Geraniol can be extracted from various species of, e.g., Cymbopogon and Pelargonium, and is a major component of citronella oil. Geraniol is a monoterpenic alcohol with a rose-like aroma. Its biological activities include antioxidant and anti-inflammatory properties, which have been described, e.g., by Mączka et al., Molecules. 2020 Jul. 21; 25(14):3303 and Lei et al., Planta Med. 2019 January; 85(1):48-55.

### Botanical Mixtures

In some embodiments, disclosed compositions comprise a plurality of tree or shrub extracts. In some embodiments, disclosed compositions comprise a combination of at least one seed extract and a tree or a shrub extract. In some embodiments, disclosed compositions comprise a combination of at least one nut extract and a tree or a shrub extract. In some embodiments, disclosed compositions comprise a combination of at least one herbal extract, seed extract, and a tree or shrub extract. In some embodiments, disclosed compositions comprise a combination of at least one herbal extract, nut extract, and tree or shrub extract. In some embodiments, disclosed compositions comprise a combination of at least one herbal extract, nut extract, seed extract, and tree or shrub extract. In some embodiments, the extract is a decoction, an oil, such as a carrier oil or an essential oil, a hydrosol, an infusion, or a tincture. In preferred embodiments, the extract, such as the herbal extract, the nut extract, the seed extract, or the tree or shrub extract is an oil, such as a carrier oil, an essential oil, or a combination thereof.

In some embodiments, the source of the herbal extract is selected from the group consisting of Hyssopus, Lavandula, Melissa, Mentha, Monarda, Nepeta, Ocimum, Origanum, Pogostemon, Salvia, Thymus, and combinations thereof. In some embodiments, the source of the herbal extract is selected from the group consisting of Hyssopus officinalis, Mentha x piperita (peppermint), Mentha spicata (spearmint), Monarda spp., Nepeta cataria (catnip), Ocimum basilicum (basil), Origanum majorana (marjoram), Origanum vulgare (oregano), Pogostemon cablin (patchouli), Salvia officinalis (sage), Thymus vulgaris (thyme), and combinations thereof.

In some embodiments, disclosed compositions comprising an herbal extract further comprise a nut extract, a seed extract, or a tree or shrub extract. In some embodiments, the extract, such as the herbal extract, the nut extract, the seed extract, or the tree or shrub extract comprises a mixture of extracts, such as a mixture of herbal extracts, nut extracts, seed extracts, or the tree or shrub extracts. In preferred embodiments, disclosed compositions comprising an herbal extract further comprise a seed extract and a tree or shrub extract. In preferred embodiments, the extract, such as the herbal extract, the seed extract, or the tree or shrub extract is an oil, such as a carrier oil or an essential oil.

In some embodiments, the source of the nut extract is selected from the group consisting of Betulaceae, Fabaceae, Juglandaceae, Rosaceae, and combinations thereof. In some embodiments, the source of the nut extract is selected from the group consisting of Arachis, Corylus, Juglans, Prunus, and combinations thereof. In some embodiments, the source of the nut extract is selected from the group consisting of Arachis hypogaea (peanut), Corylus avellana (hazelnut), Juglans regia (walnut), Prunus dulcis (almond), and combinations thereof. In some embodiments, the nut extract is a nut oil. In some embodiments, the nut extract comprises a mixture of nut extracts.

In some embodiments, disclosed compositions comprising a nut extract further comprise an herbal extract, a seed extract, or a tree or shrub extract. In some embodiments, the extract, such as the herbal extract, the nut extract, the seed extract, or the tree or shrub extract comprises a mixture of extracts, such as a mixture of herbal extracts, nut extracts, seed extracts, or the tree or shrub extracts.

In some embodiments, the source of the seed extract is selected from the group consisting of Asteraceae, Cannabaceae, Cucurbitaceae, Lamiaceae, Linaceae, Pedaliaceae, and combinations thereof. In some embodiments, the source of the seed extract is selected from the group consisting of Brassica, Cannabis, Carum, Coriandrum, Cucurbita, Cuminum, Foeniculum, Gossypium, Helianthus, Linum, Malvaceae, Nigella, Piper, Salvia, Sesamum, and combinations thereof. In some embodiments, the source of the seed extract is selected from the group consisting of Brassica napus (rapeseed), Cannabis sativa (hemp seed), Carum carvi (caraway seed), Coriandrum sativum (coriander seed), Cucurbita pepo (also referred to as Cucurbita maxima or Cucurbita moschata) (pumpkin seed), Cuminum cyminum (cumin seed), Foeniculum vulgare (fennel seed), Gossypium herbaceum (cottonseed), Gossypium hirsutum (cottonseed), Helianthus annuus (sunflower seed), Linum usitatissimum (flax seed), Nigella sativa (black cumin seed), Piper nigrum (black pepper seed), Salvia hispanica (chia seed), Sesamum indicum (sesame seed), and combinations thereof.

In some embodiments, disclosed compositions comprising a seed extract further comprise an herbal extract, a nut extract, or a tree or shrub extract. In some embodiments, the extract, such as the herbal extract, the nut extract, the seed extract, or the tree or shrub extract comprises a mixture of extracts, such as a mixture of herbal extracts, nut extracts, seed extracts, or the tree or shrub extracts. In preferred embodiments, disclosed compositions comprising a seed extract further comprise an herbal extract and a tree or shrub extract. In preferred embodiments, the extract, such as the herbal extract, the seed extract, or the tree or shrub extract is an oil, such as a carrier oil or an essential oil.

In some embodiments, the source of the tree or shrub extract is selected from the group consisting of Arecaceae, Azadirachta, Cupressaceae, Geraniaceae, Lamiaceae, Pinaceae, Poaceae, Santalaceae, and combinations thereof. In some embodiments, the source of the tree or shrub extract is selected from the group consisting of Abies, Azadirachta, Cedrus, Cocos, Cupressaceae, Elaeis, Juniperus, Larix, Myrtaceae, Pelargonium, Picea, Pinus, Rosmarinus, Santalaceae, Syzygium, Tsuga, and combinations thereof. In some embodiments, the source of the tree or shrub extract is selected from the group consisting of Abies grandis, Abies concolor, Abies lasiocarpa, Azadirachta indica, Cedrus atlantica, Cedrus brvifolia, Cedrus deodara, Cedrus libani, Cocos nucifera, Cymbopogon nardus, Cupressus sempervirens, Elaeis guineensis, Elaeis oleifera, Eucalyptus globulus, Eucalyptus radiata, Juniperus ashei, Juniperus Mexicana, Juniperus virginiana, Larix decidua, Larix laricina, Pelargonium asperum, Pelargonium capitatum, Pelargonium graveolens (L.), Picea mariana, Picea omorika, Picea pungens, Pinus pinaster, Pinus radiata, Pinus strobus, Rosmarinus officianalis, Santalum album, Santalum spicatum, Syzygium aromaticum, Tsuga canadensis, Tsuga heterophylla, and combinations thereof.

In some embodiments, disclosed compositions comprising a tree or shrub further comprise an herbal extract, a nut extract, or a seed extract. In some embodiments, the extract, such as the herbal extract, the nut extract, the seed extract, or the tree or shrub extract comprises a mixture of extracts, such as a mixture of herbal extracts, nut extracts, seed extracts, or the tree or shrub extracts. In preferred embodiments, disclosed compositions comprising a tree or shrub extract further comprise an herbal extract and a seed extract. In preferred embodiments, the extract, such as the herbal extract, the seed extract, or the tree or shrub extract is an oil, such as a carrier oil or an essential oil.

In some embodiments, disclosed compositions comprise at least one Lamiaceae extract and one or both of a Cupressaceae extract and a Pinaceae extract. In some embodiments, disclosed compositions comprise at least one Lamiaceae extract and a Myrtaceae extract. In some embodiments, disclosed compositions comprise at least one Lamiaceae extract, a Myrtaceae extract, and one or both of a Cupressaceae extract and a Pinaceae extract.

In some embodiments, disclosed compositions comprise at least one Lamiaceae extract, a Pedaliaceae extract, and one or both of a Cupressaceae extract and a Pinaceae extract. In some embodiments, disclosed compositions comprise at least one Lamiaceae extract, a Myrtaceae extract, and a Pedaliaceae extract. In some embodiments, disclosed compositions comprise at least one Lamiaceae extract, a Myrtaceae extract, a Pedaliaceae extract, and one or both of a Cupressaceae extract and a Pinaceae extract.

In some embodiments, disclosed compositions comprise a Thymus extract and one or both of a Cedrus extract and a Juniperus extract. In some embodiments, disclosed compositions comprise a Mentha extract one or both of a Cedrus extract and a Juniperus extract. In some embodiments, disclosed compositions comprise a Syzgium extract and a Thymus extract. In some embodiments, disclosed compositions comprise a Syzgium extract and a Mentha extract.

In some embodiments, disclosed compositions comprise a Syzgium extract, a Thymus extract, and one or both of a Cedrus extract and a Juniperus extract. In some embodiments, disclosed compositions comprise a Mentha extract, a Syzgium extract, and one or both of a Cedrus extract and a Juniperus extract. In some embodiments, disclosed compositions comprise a Sesamum extract, a Syzgium extract, a Thymus extract, and one or both of a Cedrus extract and a Juniperus extract. In some embodiments, disclosed compositions comprise a Mentha extract, a Sesamum extract, a Syzgium extract, and one or both of a Cedrus extract and a Juniperus extract.

In some embodiments, disclosed compositions comprise a Mentha extract, a Syzgium extract, a Thymus extract, and one or both of a Cedrus extract and a Juniperus extract. In some embodiments, disclosed compositions comprise a Mentha extract, a Sesamum extract, a Syzgium extract, a Thymus extract, and one or both of a Cedrus extract and a Juniperus extract.

In some embodiments, disclosed compositions comprise a compound selected from the group consisting of α-terpinene, γ-terpinene, 1,8-cineole, menthone, mentho-furan, menthol, iso-menthol, neo-iso-menthol, pulegone, neo-menthyl acetate, piperitone, menthyl acetate, E-caryophyllene, germacrene D, α-pinene, camphene, β-pinene, myrcene, α-terpinene, p-cymene, limonene, 1,8-cineole, γ-terpinene, terpinolene, linalool, borneol, terpinen-4-ol, α-terpineol, carvacrol methyl ether, linalyl acetate, thymol, carvacrol, longifolene, (e)-β-caryophyllene, α-humulene, caryophyllene oxide, sesamol, sesamolin, sesamin, pinoresinol, cedr-9-en, 7-epi-α-Cedrene, α-cedrene, β-cedrene, thujopsene, ar-curcumene, cis-β-guaiene, α-cuprenene, trans-calamenene, γ-cuprenene, cedrol, 12-epi-cedrol, γ-eudesmol, α-cadinol, α-eudesmol, β-bisabolol, 1H-benzocycloheptene, 2,4a,5,6,7,8-hexahydro-3,5,5,9-tetramethyl-(R), cedr-9-en, 7-epi-α-cedrene, α-copaene, methyl thujate, thujic acid, α-thujaplicin, β-thujaplicin cedrol, (+)-cuparene, widdrol, combinations thereof, and derivatives thereof.

In some embodiments, disclosed compositions comprise α-cedrene, eugenol, and menthol and/or thymol. In some embodiments, disclosed compositions further comprise sesamolin. In some embodiments, disclosed compositions consist essentially of α-cedrene, eugenol, menthol, thymol, and sesamolin. In some embodiments, disclosed compositions comprise a derivative of at least one of α-cedrene, eugenol, menthol, thymol, and sesamolin.

In some embodiments, disclosed compositions comprise at least one of α-cedrene, eugenol, menthol, thymol, sesamolin, or a derivative thereof in an amount of about 0.1-5%, 0.1-10%, 0.1-15%, 0.1-20% (w/v), 0.1-25% (w/v), 0.1-30% (w/v), 0.1-35% (w/v), 0.1-40% (w/v), 0.1-45% (w/v), or 0.1-50% (w/v) each. In some embodiments, disclosed compositions comprise at least one of α-cedrene, eugenol, menthol, thymol, sesamolin, or a derivative thereof in an amount of about 1-5%, 1-10%, 1-15%, 1-20% (w/v), 1-25% (w/v), 1-30% (w/v), 1-35% (w/v), 1-40% (w/v), 1-45% (w/v), or 1-50% (w/v) each. In some embodiments, disclosed compositions comprise at least one of α-cedrene, eugenol, menthol, thymol, sesamolin, or a derivative thereof in an amount of about 5-10% (w/v), 5-15% (w/v), 5-20% (w/v), 5-25% (w/v), 5-30% (w/v), 5-35% (w/v), 5-40% (w/v), 5-45% (w/v), or 5-50% (w/v) each. In some embodiments, disclosed compositions comprise at least one of α-cedrene, eugenol, menthol, thymol, sesamolin, or a derivative thereof in an amount of about 10-15% (w/v), 10-20% (w/v), 10-25% (w/v), 10-30% (w/v), 10-35% (w/v), 10-40% (w/v), 10-45% (w/v), or 10-50% (w/v) each.

In some embodiments, the extract is a decoction, an oil, such as a carrier oil or an essential oil, a hydrosol, an infusion, or a tincture. In preferred embodiments, the extract is an oil, such as a carrier oil or an essential oil. In some embodiments, disclosed compositions comprise the components of the combination, such as the oils, in equivalent amounts. In some embodiments, disclosed compositions comprise the components of the combination in different amounts.

In some embodiments, disclosed compositions comprise a combination of a cedarwood extract, a clove extract, and a sesame extract. In some embodiments, disclosed compositions comprise a combination of a cedarwood extract, a clove extract, and a sesame extract in equivalent amounts, such as in a volume ratio of about 1:1:1. In some embodiments, disclosed compositions comprise a combination of a cedarwood extract, a clove extract, and a sesame extract in different amounts. In preferred embodiments, the extract is an oil. In some of any embodiments, a cedar extract, such as cedar oil may replace a cedarwood extract, such as cedarwood oil, or be used in combination with the same.

In some embodiments, disclosed compositions comprise a combination of cedarwood oil, clove oil, and sesame oil. In some embodiments, disclosed compositions comprise a combination of combination of cedarwood oil, clove oil, and sesame oil in equivalent amounts, such as in a volume ratio of about 1:1:1. In some embodiments, disclosed compositions comprise a combination of cedarwood oil, clove oil, and sesame oil in different amounts.

In some embodiments, disclosed compositions comprise a combination of cedarwood oil, clove oil, and sesame oil in a volume ratio of about 2:1:1, 1:2:1, 1:1:2, respectively. In some embodiments, disclosed compositions comprise a combination of cedarwood oil, clove oil, and sesame oil in a volume ratio of about 1:1:3, 1:1:4, 1:1:5, 1:2:2, 1:2:3, 1:2:4, 1:2:5, 1:3:3, 1:3:4, 1:3:5, 1:4:4, 1:4:5, 1:5:5, 2:2:2, 2:2:3, 2:2:4, 2:2:5, 2:3:3, 2:3:4, 2:3:5, 2:4:4, 2:4:5, 2:5:5, 3:3:3, 3:3:4, 3:3:5, 3:4:4, 3:4:5, 3:5:5, 4:4:4, 4:4:5, 4:5:5, or 5:5:5, respectively.

In some embodiments, disclosed compositions comprise a combination of at least about 0.1% v/v cedarwood oil, 0.1% v/v clove oil, and 0.1% v/v sesame oil. In some embodiments, disclosed compositions comprise a combination of at least about 1% v/v cedarwood oil, 1% v/v clove oil, and 1% v/v sesame oil. In some embodiments, disclosed compositions comprise a combination of at least about 5% v/v cedarwood oil, 5% v/v clove oil, and 5% v/v sesame oil. In some embodiments, disclosed compositions comprise a combination of at least about 10% v/v cedarwood oil, 10% v/v clove oil, and 10% v/v sesame oil.

In some embodiments, disclosed compositions comprise a combination of about 1-20% v/v cedarwood oil, 1-20% v/v clove oil, and 1-20% v/v sesame oil, inclusive. In some embodiments, disclosed compositions comprise a combination of about 1-10% v/v cedarwood oil, 1-10% v/v clove oil, and 1-10% v/v sesame oil, inclusive. In some embodiments, disclosed compositions comprise a combination of about 1-5% v/v cedarwood oil, 1-5% v/v clove oil, and 1-5% v/v sesame oil, inclusive.

In some embodiments, disclosed compositions comprise a combination of a cedarwood extract, a clove extract, a mint extract, and a sesame extract. In some embodiments, disclosed compositions comprise a combination of combination of a cedarwood extract, a clove extract, a mint extract, and a sesame extract in equivalent amounts, such as in a volume ratio of about 1:1:1:1. In some embodiments, disclosed compositions comprise a combination of a cedarwood extract, a clove extract, a mint extract, and a sesame extract in different amounts. In preferred embodiments, the extract is an oil.

In some embodiments, disclosed compositions comprise a combination of cedarwood oil, clove oil, peppermint oil, and sesame oil. In some embodiments, disclosed compositions comprise a combination of combination of cedarwood oil, clove oil, peppermint oil, and sesame oil in equivalent amounts, such as in a volume ratio of about 1:1:1:1. In some embodiments, disclosed compositions comprise a combination of cedarwood oil, clove oil, peppermint oil, and sesame oil in different amounts.

In some embodiments, disclosed compositions comprise a combination of cedarwood oil, clove oil, peppermint oil, and sesame oil in a volume ratio of about 1:1:1:1, 1:1:1:2, 1:1:1:3, 1:1:1:4, 1:1:1:5, 1:1:2:2, 1:1:2:3, 1:1:2:4, 1:1:2:5, 1:1:3:3, 1:1:3:4, 1:1:3:5, 1:1:4:4, 1:1:4:5, 1:1:5:5, 1:2:2:2, 1:2:2:3, 1:2:2:4, 1:2:2:5, 1:2:3:3, 1:2:3:4, 1:2:3:5, 1:2:4:4, 1:2:4:5, 1:2:5:5, 1:3:3:3, 1:3:3:4, 1:3:3:5, 1:3:4:4, 1:3:4:5, 1:3:5:5, 1:4:4:4, 1:4:4:5, 1:4:5:5, 1:5:5:5, 2:2:2:2, 2:2:2:3, 2:2:2:4, 2:2:2:5, 2:2:3:3, 2:2:3:4, 2:2:3:5 2:2:4:4, 2:2:4:5, 2:2:5:5, 2:3:3:3, 2:3:3:4, 2:3:3:5, 2:3:4:4, 2:3:4:5, 2:3:5:5, 2:4:4:4, 2:4:4:5, 2:4:5:5, 2:5:5:5, 3:3:3:3, 3:3:3:4, 3:3:3:5, 3:3:4:4, 3:3:4:5, 3:3:5:5, 3:4:4:4, 3:4:4:5, 3:4:5:5, 3:5:5:5, 4:4:4:4, 4:4:4:5, 4:4:5:5, 4:5:5:5, or 5:5:5:5, respectively.

In some embodiments, disclosed compositions comprise a combination of at least about 0.1% v/v cedarwood oil, 0.1% v/v clove oil, 0.1% v/v peppermint oil, and 0.1% v/v sesame oil. In some embodiments, disclosed compositions comprise a combination of at least about 1% v/v cedarwood oil, 1% v/v clove oil, 1% v/v peppermint oil, and 1% v/v sesame oil. In some embodiments, disclosed compositions comprise a combination of at least about 5% v/v cedarwood oil, 5% v/v clove oil, 5% v/v peppermint oil, and 5% v/v sesame oil. In some embodiments, disclosed compositions comprise a combination of at least about 10% v/v cedarwood oil, 10% v/v clove oil, 10% v/v peppermint oil, and 10% v/v sesame oil.

In some embodiments, disclosed compositions comprise a combination of about 1-20% v/v cedarwood oil, 1-20% v/v clove oil, 1-20% v/v peppermint oil, and 1-20% v/v sesame oil, inclusive. In some embodiments, disclosed compositions comprise a combination of about 1-10% v/v cedarwood oil, 1-10% v/v clove oil, 1-10% v/v peppermint oil, and 1-10% v/v sesame oil, inclusive. In some embodiments, disclosed compositions comprise a combination of about 1-5% v/v cedarwood oil, 1-5% v/v clove oil, 1-5% v/v peppermint oil, and 1-5% v/v sesame oil, inclusive.

In some embodiments, disclosed compositions comprise a combination of a cedarwood extract, a clove extract, a sesame extract, and a thyme extract. In some embodiments, disclosed compositions comprise a combination of combination of a cedarwood extract, a clove extract, a sesame extract, and a thyme extract in equivalent amounts, such as in a volume ratio of about 1:1:1:1. In some embodiments, disclosed compositions comprise a combination of a cedarwood extract, a clove extract, a sesame extract, and a thyme extract in different amounts. In preferred embodiments, the extract is an oil.

In some embodiments, disclosed compositions comprise a combination of cedarwood oil, clove oil, sesame oil, and thyme oil. In some embodiments, disclosed compositions comprise a combination of combination of cedarwood oil, clove oil, sesame oil, and thyme oil in equivalent amounts, such as in a volume ratio of about 1:1:1:1. In some embodiments, disclosed compositions comprise a combination of cedarwood oil, clove oil, sesame oil, and thyme oil in different amounts.

In some embodiments, disclosed compositions comprise a combination of cedarwood oil, clove oil, sesame oil, and thyme oil in a volume ratio of about 1:1:1:1, 1:1:1:2, 1:1:1:3, 1:1:1:4, 1:1:1:5, 1:1:2:2, 1:1:2:3, 1:1:2:4, 1:1:2:5, 1:1:3:3, 1:1:3:4, 1:1:3:5, 1:1:4:4, 1:1:4:5, 1:1:5:5, 1:2:2:2, 1:2:2:3, 1:2:2:4, 1:2:2:5, 1:2:3:3, 1:2:3:4, 1:2:3:5, 1:2:4:4, 1:2:4:5, 1:2:5:5, 1:3:3:3, 1:3:3:4, 1:3:3:5, 1:3:4:4, 1:3:4:5, 1:3:5:5, 1:4:4:4, 1:4:4:5, 1:4:5:5, 1:5:5:5, 2:2:2:2, 2:2:2:3, 2:2:2:4, 2:2:2:5, 2:2:3:3, 2:2:3:4, 2:2:3:5 2:2:4:4, 2:2:4:5, 2:2:5:5, 2:3:3:3, 2:3:3:4, 2:3:3:5, 2:3:4:4, 2:3:4:5, 2:3:5:5, 2:4:4:4, 2:4:4:5, 2:4:5:5, 2:5:5:5, 3:3:3:3, 3:3:3:4, 3:3:3:5, 3:3:4:4, 3:3:4:5, 3:3:5:5, 3:4:4:4, 3:4:4:5, 3:4:5:5, 3:5:5:5, 4:4:4:4, 4:4:4:5, 4:4:5:5, 4:5:5:5, or 5:5:5:5, respectively.

In some embodiments, disclosed compositions comprise a combination of at least about 0.1% v/v cedarwood oil, 0.1% v/v clove oil, 0.1% v/v sesame oil, and 0.1% v/v thyme oil. In some embodiments, disclosed compositions comprise a combination of at least about 1% v/v cedarwood oil, 1% v/v clove oil, 1% v/v sesame oil, and 1% v/v thyme oil. In some embodiments, disclosed compositions comprise a combination of at least about 5% v/v cedarwood oil, 5% v/v clove oil, 5% v/v sesame oil, and 5% v/v thyme oil. In some embodiments, disclosed compositions comprise a combination of at least about 10% v/v cedarwood oil, 10% v/v clove oil, 10% v/v sesame oil, and 10% v/v thyme oil.

In some embodiments, disclosed compositions comprise a combination of about 1-20% v/v cedarwood oil, 1-20% v/v clove oil, 1-20% v/v sesame oil, and 1-20% v/v thyme oil, inclusive. In some embodiments, disclosed compositions comprise a combination of about 1-10% v/v cedarwood oil, 1-10% v/v clove oil, 1-10% v/v sesame oil, and 1-10% v/v thyme oil, inclusive. In some embodiments, disclosed compositions comprise a combination of about 1-5% v/v cedarwood oil, 1-5% v/v clove oil, 1-5% v/v sesame oil, and 1-5% v/v thyme oil, inclusive.

In some embodiments, disclosed compositions comprise a combination of a cedarwood extract, a clove extract, a mint extract, a sesame extract, and a thyme extract. In some embodiments, disclosed compositions comprise a combination of combination of a cedarwood extract, a clove extract, a mint extract, a sesame extract, and a thyme extract in equivalent amounts, such as in a volume ratio of about 1:1:1:1. In some embodiments, disclosed compositions comprise a combination of a cedarwood extract, a clove extract, a mint extract, a sesame extract, and a thyme extract in different amounts. In preferred embodiments, the extract is an oil.

In some embodiments, disclosed compositions comprise a combination of cedarwood oil, clove oil, peppermint oil, sesame oil, and thyme oil. In some embodiments, disclosed compositions comprise a combination of cedarwood oil, clove oil, peppermint oil, sesame oil, and thyme oil in equivalent amounts, such as in a volume ratio of about 1:1:1:1:1. In some embodiments, disclosed compositions comprise a combination of cedarwood oil, clove oil, peppermint oil, sesame oil, and thyme oil in different amounts.

In some embodiments, disclosed compositions comprise a combination of cedarwood oil, clove oil, peppermint oil, sesame oil, and thyme oil in a volume ratio of about 2:1:1:1:1, 1:2:1:1:1, 1:1:2:1:1, 1:1:1:2:1, or 1:1:1:1:2, respectively. In some embodiments, disclosed compositions comprise a combination of cedarwood oil, clove oil, peppermint oil, sesame oil, and thyme oil in a volume ratio of about 1:1:1:1:1, 1:1:1:1:2, 1:1:1:1:3, 1:1:1:1:4, 1:1:1:1:5, 1:1:1:2:2, 1:1:1:2:3, 1:1:1:2:4, 1:1:1:2:5, 1:1:1:3:3, 1:1:1:3:4, 1:1:1:3:5, 1:1:1:4:4, 1:1:1:4:5, 1:1:1:5:5, 1:1:2:2:2, 1:1:2:2:3, 1:1:2:2:4, 1:1:2:2:5, 1:1:2:3:3, 1:1:2:3:4, 1:1:2:3:5, 1:1:2:4:4, 1:1:2:4:5, 1:1:2:5:5, 1:1:3:3:3, 1:1:3:3:4, 1:1:3:3:5, 1:1:3:4:4, 1:1:3:4:5, 1:1:3:5:5, 1:1:4:4:4, 1:1:4:4:5, 1:1:4:5:5, 1:1:5:5:5, 1:2:2:2:2, 1:2:2:2:3, 1:2:2:2:4, 1:2:2:2:5, 1:2:2:3:3, 1:2:2:3:4, 1:2:2:3:5, 1:2:2:4:4, 1:2:2:4:5, 1:2:2:5:5, 1:2:3:3:3, 1:2:3:3:4, 1:2:3:3:5, 1:2:3:4:4, 1:2:3:4:5, 1:2:3:5:5, 1:2:4:4:4, 1:2:4:4:5, 1:2:4:5:5, 1:2:5:5:5, 1:3:3:3:3, 1:3:3:3:4, 1:3:3:3:5, 1:3:3:4:4, 1:3:3:4:5, 1:3:3:5:5, 1:3:4:4:4, 1:3:4:4:5, 1:3:4:5:5, 1:3:5:5:5, 1:4:4:4:4, 1:4:4:4:5, 1:4:4:5:5, 1:4:5:5:5, 1:5:5:5:5, 2:2:2:2:2, 2:2:2:2:3, 2:2:2:2:4, 2:2:2:2:5, 2:2:2:3:3, 2:2:2:3:4, 2:2:2:3:5, 2:2:2:4:4, 2:2:2:4:5, 2:2:2:5:5, 2:2:3:3:3, 2:2:3:3:4, 2:2:3:3:5, 2:2:3:4:4, 2:2:3:4:5, 2:2:3:5:5, 2:2:4:4:4, 2:2:4:4:5, 2:2:4:5:5, 2:2:5:5:5, 2:3:3:3:3, 2:3:3:3:4, 2:3:3:3:5, 2:3:3:4:4. 2:3:3:4:5, 2:3:3:5:5, 2:3:4:4:4, 2:3:4:4:5, 2:3:4:5:5, 2:3:5:5:5, 2:4:4:4:4, 2:4:4:4:5, 2:4:4:5:5, 2:4:5:5:5, 2:5:5:5:5, 3:3:3:3:3, 3:3:3:3:4, 3:3:3:3:5, 3:3:3:4:4, 3:3:3:4:5, 3:3:3:5:5, 3:3:4:4:4, 3:3:4:4:5, 3:3:4:5:5, 3:3:4:5:5, 3:3:5:5:5, 3:4:4:4:4, 3:4:4:4:5, 3:4:4:5:5, 3:4:5:5:5, 3:5:5:5:5, 4:4:4:4:4, 4:4:4:4:5, 4:4:4:5:5, 4:4:5:5:5, 4:5:5:5:5, or 5:5:5:5:5.

In some embodiments, disclosed compositions comprise a combination of at least about 0.1% v/v cedarwood oil, 0.1% v/v clove oil, 0.1% v/v peppermint oil, 0.1% v/v sesame oil, and 0.1% v/v thyme oil. In some embodiments, disclosed compositions comprise a combination of at least about 1% v/v cedarwood oil, 1% v/v clove oil, 1% v/v peppermint oil, 1% v/v sesame oil, and 1% v/v thyme oil. In some embodiments, disclosed compositions comprise a combination of at least about 5% v/v cedarwood oil, 5% v/v clove oil, 5% v/v peppermint oil, 5% v/v sesame oil, and 5% v/v thyme oil. In some embodiments, disclosed compositions comprise a combination of at least about 10% v/v cedarwood oil, 10% v/v clove oil, 10% v/v peppermint oil, 10% v/v sesame oil, and 10% v/v thyme oil.

In some embodiments, disclosed compositions comprise a combination of about 1-20% v/v cedarwood oil, 1-20% v/v clove oil, 1-20% v/v peppermint oil, 1-20% v/v sesame oil, and 1-20% v/v thyme oil, inclusive. In some embodiments, disclosed compositions comprise a combination of at least about 1-10% v/v cedarwood oil, 1-10% v/v clove oil, 1-10% v/v peppermint oil, 1-10% v/v sesame oil, and 1-10% v/v thyme oil, inclusive. In some embodiments, disclosed compositions comprise a combination of at least about 1-5% v/v cedarwood oil, 1-5% v/v clove oil, 1-5% v/v peppermint oil, 1-5% v/v sesame oil, and 1-5% v/v thyme oil, inclusive.

In some embodiments, disclosed compositions comprise a combination of at least about 5% v/v cedarwood oil, 10% v/v clove oil, 5% v/v peppermint oil, 5% v/v sesame oil, and 5% v/v thyme oil. In some embodiments, disclosed compositions comprise a combination of at least about 5% v/v cedarwood oil, 5% v/v clove oil, 10% v/v peppermint oil, 5% v/v sesame oil, and 5% v/v thyme oil. In some embodiments, disclosed compositions comprise a combination of at least about 5% v/v cedarwood oil, 5% v/v clove oil, 5% v/v peppermint oil, 10% v/v sesame oil, and 5% v/v thyme oil. In some embodiments, disclosed compositions comprise a combination of at least about 5% v/v cedarwood oil, 5% v/v clove oil, 5% v/v peppermint oil, 5% v/v sesame oil, and 10% v/v thyme oil. In some embodiments, disclosed compositions comprise a combination of up to about 20% v/v cedarwood oil, 20% v/v clove oil, 20% v/v peppermint oil, 20% v/v sesame oil, and 20% v/v thyme oil. In some embodiments, disclosed compositions comprise a combination of about 10% v/v cedarwood oil, 5% v/v clove oil, 5% v/v peppermint oil, 5% v/v sesame oil, and 5% v/v thyme oil.

In some embodiments, disclosed compositions comprise at least one Lamiaceae extract and one or both of a Cupressaceae extract and a Pinaceae extract. In some embodiments, disclosed compositions comprise at least one Lamiaceae extract and a Myrtaceae extract. In some embodiments, disclosed compositions comprise at least one Lamiaceae extract, a Myrtaceae extract, and one or both of a Cupressaceae extract and a Pinaceae extract.

In some embodiments, disclosed compositions comprise at least one Cupressaceae, Poaceae, and Lamiaceae extract. In some embodiments, disclosed compositions further comprise a Pinaceae extract. In some embodiments, disclosed compositions comprise a Cupressaceae, a Poaceae, a Lamiaceae, and a Pinaceae extract.

In some embodiments, disclosed compositions comprise at least one Cymbopogon extract, Rosmarinus extract, and Syzgium extract. In some embodiments, disclosed compositions further comprise at least one Cedrus extract, Juniperus extract, or a combination thereof. In some embodiments, disclosed compositions comprise a Cymbopogon extract, a Rosmarinus extract, a Syzgium extract, and a Cedrus extract. In some embodiments, disclosed compositions comprise a Cymbopogon extract, a Rosmarinus extract, a Syzgium extract, and a Juniperus extract. In some embodiments, disclosed compositions comprise a Cymbopogon extract, a Rosmarinus extract, a Syzgium extract, a Cedrus extract, and a Juniperus extract.

In some embodiments, disclosed compositions comprise geraniol, and at least one Rosmarinus extract and Syzgium extract. In some embodiments, disclosed compositions further comprise at least one Cedrus extract, Juniperus extract, or a combination thereof. In some embodiments, disclosed compositions comprise geraniol, a Rosmarinus extract, a Syzgium extract, and a Cedrus extract. In some embodiments, disclosed compositions comprise geraniol, a Rosmarinus extract, a Syzgium extract, and a Juniperus extract. In some embodiments, disclosed compositions comprise a geraniol, a Rosmarinus extract, a Syzgium extract, a Cedrus extract, and a Juniperus extract.

In some embodiments, disclosed compositions comprise a compound selected from the group consisting of citronellal, citronellol, geraniol, 4-elemene, germacene-d, elemol, germacredien-5-ol, elemol, α-amorfene, β-selinene, 16-eudesml, α-selinene, α-eudesmol, and α-muuorele, α-pinene, linalool, cis-rose oxide, trans-rose oxide, menthone, citronellol, geraniol, citronellyl formate, geranyl formate, citronellyl acetate, α-copaene, geranyl acetate, guaiadiene, caryophellene, citronellyl propanoate, α-agarofuran, geranyl n-butyrate, phenylethyl tiglate, 10-epi-gamma-eudesmol, citronellyl tiglate, geranyl tiglate, myrcene, α-phellandrene, limonene, 1,8-cineol, β-phellandrene, γ-terpinene, p-cymene, terpinolene, cis-rose oxide, trans-rose oxide, trans-linalool oxide (furanoid), isomenthone, α-bourbonene, β-bourbonene, α-guaiene, β-caryophyllene, 6,9-guaidiene, menthol, aromadendrene, alloaromadendrene, epi-zonarene, α-humulene, α-terpineol, geranyl formate, ledene, germacrene, citronellyl propionate, α-muurolene, bicyclogermacrene, δ-cadinene, γ-cadinene, nerol, citronellyl butyrate, calamelene, myrtanol, geranyl butyrate, citronellyl, 4-methyl valerate, 1,10-di-epi-cubenol, cedr-9-en, 7-epi-α-Cedrene, α-cedrene, β-cedrene, thujopsene, ar-curcumene, cis-β-guaiene, α-cuprenene, cuparene, trans-calamenene, γ-cuprenene, cedrol, 12-epi-cedrol, γ-eudesmol, α-cadinol, α-eudesmol, β-bisabolol, 1H-benzocycloheptene, 2,4a,5,6,7,8-hexahydro-3,5,5,9-tetramethyl-(R) (5.01%), and (+)-cuparene, 1,8-cineole (eucalyptol), α-pinene, camphene, β-pinene, β-myrcene, α-phellandrene, limonene, γ-terpinene, 1,8-cineole, linalool, (+)-camphor, isoborneol, borneol, α-terpineol, verbenone, β-caryophyllene, β-farnesene, γ-muurolene, caryophyllene oxide, tricyclene, 3-octanone, carnosol, carnosic acid, ursolic acid, rosmarinic acid, genkwanin, luteolin-7-O-glucoside, homoplantaginin, epigallocatechin, quinic acid, syringic acid, neohesperidin, eugenol, isoeugenol, caryophyllene, humulene, α-amorphene, acetyleugenol, combinations thereof, and derivatives thereof.

In some embodiments, disclosed compositions comprise geraniol, eugenol, and 1,8-cineole. In some embodiments, disclosed compositions further comprise α-cedrene. In preferred embodiments, disclosed compositions comprise geraniol, eugenol, and 1,8-cineole, and α-cedrene. In some embodiments, disclosed compositions further comprise sesamolin. In some embodiments, disclosed compositions consist essentially of a geraniol, α-cedrene, eugenol, and 1,8-cineole. In some embodiments, disclosed compositions comprise a derivative of at least one of geraniol, α-cedrene, eugenol, and 1,8-cineole.

In some embodiments, disclosed compositions comprise at least one of 1,8-cineole, eugenol, geraniol, or a derivative thereof in an amount of about 0.1-5%, 0.1-10%, 0.1-15%, 0.1-20% (w/v), 0.1-25% (w/v), 0.1-30% (w/v), 0.1-35% (w/v), 0.1-40% (w/v), 0.1-45% (w/v), or 0.1-50% (w/v) each. In some embodiments, disclosed compositions comprise at least one of 1,8-cineole, eugenol, geraniol, or a derivative thereof in an amount of about 1-5%, 1-10%, 1-15%, 1-20% (w/v), 1-25% (w/v), 1-30% (w/v), 1-35% (w/v), 1-40% (w/v), 1-45% (w/v), or 1-50% (w/v) each. In some embodiments, disclosed compositions comprise at least one of 1,8-cineole, eugenol, geraniol, or a derivative thereof in an amount of about 5-10% (w/v), 5-15% (w/v), 5-20% (w/v), 5-25% (w/v), 5-30% (w/v), 5-35% (w/v), 5-40% (w/v), 5-45% (w/v), or 5-50% (w/v) each. In some embodiments, disclosed compositions comprise at least one of 1,8-cineole, eugenol, geraniol, or a derivative thereof in an amount of about 10-15% (w/v), 10-20% (w/v), 10-25% (w/v), 10-30% (w/v), 10-35% (w/v), 10-40% (w/v), 10-45% (w/v), or 10-50% (w/v) each.

In some embodiments, disclosed compositions comprise at least one of 1,8-cineole, eugenol, geraniol, α-cedrene, or a derivative thereof in an amount of about 0.1-5%, 0.1-10%, 0.1-15%, 0.1-20% (w/v), 0.1-25% (w/v), 0.1-30% (w/v), 0.1-35% (w/v), 0.1-40% (w/v), 0.1-45% (w/v), or 0.1-50% (w/v) each. In some embodiments, disclosed compositions comprise at least one of 1,8-cineole, eugenol, geraniol, α-cedrene, or a derivative thereof in an amount of about 1-5%, 1-10%, 1-15%, 1-20% (w/v), 1-25% (w/v), 1-30% (w/v), 1-35% (w/v), 1-40% (w/v), 1-45% (w/v), or 1-50% (w/v) each. In some embodiments, disclosed compositions comprise at least one of 1,8-cineole, eugenol, geraniol, α-cedrene, or a derivative thereof in an amount of about 5-10% (w/v), 5-15% (w/v), 5-20% (w/v), 5-25% (w/v), 5-30% (w/v), 5-35% (w/v), 5-40% (w/v), 5-45% (w/v), or 5-50% (w/v) each. In some embodiments, disclosed compositions comprise at least one of 1,8-cineole, eugenol, geraniol, α-cedrene, or a derivative thereof in an amount of about 10-15% (w/v), 10-20% (w/v), 10-25% (w/v), 10-30% (w/v), 10-35% (w/v), 10-40% (w/v), 10-45% (w/v), or 10-50% (w/v) each.

In some embodiments, the extract is a decoction, an oil, such as a carrier oil or an essential oil, a hydrosol, an infusion, or a tincture. In preferred embodiments, the extract is an oil, such as a carrier oil or an essential oil. In some embodiments, disclosed compositions comprise the components of the combination, such as the oils, in equivalent amounts. In some embodiments, disclosed compositions comprise the components of the combination in different amounts.

In some embodiments, disclosed compositions comprise a combination of geraniol, a clove extract, and a rosemary extract. In some embodiments, disclosed compositions comprise a combination of geraniol, a clove extract, and a rosemary extract in equivalent amounts, such as in a volume ratio of about 1:1:1. In some embodiments, disclosed compositions further comprise a cedarwood extract, such as in an equivalent amount, e.g., a volume ratio of 1:1:1:1. In some embodiments, disclosed compositions comprise a combination of geraniol, a clove extract, and a rosemary extract or a combination of geraniol, a clove extract, a rosemary extract, and a cedarwood extract in different amounts. In preferred embodiments, the extract is an oil. In some of any embodiments, a cedar extract, such as cedar oil may replace a cedarwood extract, such as cedarwood oil, or be used in combination with the same.

In some embodiments, disclosed compositions comprise a combination of geraniol, clove oil, and rosemary oil in a volume ratio of about 2:1:1, 1:2:1, 1:1:2, respectively. In some embodiments, disclosed compositions comprise a combination of geraniol, clove oil, and rosemary oil in a volume ratio of about 1:1:3, 1:1:4, 1:1:5, 1:2:2, 1:2:3, 1:2:4, 1:2:5, 1:3:3, 1:3:4, 1:3:5, 1:4:4, 1:4:5, 1:5:5, 2:2:2, 2:2:3, 2:2:4, 2:2:5, 2:3:3, 2:3:4, 2:3:5, 2:4:4, 2:4:5, 2:5:5, 3:3:3, 3:3:4, 3:3:5, 3:4:4, 3:4:5, 3:5:5, 4:4:4, 4:4:5, 4:5:5, or 5:5:5, respectively.

In some embodiments, disclosed compositions comprise a combination of at least about 0.1% v/v geraniol, 0.1% v/v clove oil, and 0.1% v/v rosemary oil. In some embodiments, disclosed compositions comprise a combination of at least about 1% v/v geraniol, 1% v/v clove oil, and 1% v/v rosemary oil. In some embodiments, disclosed compositions comprise a combination of at least about 5% v/v geraniol, 5% v/v clove oil, and 5% v/v rosemary oil. In some embodiments, disclosed compositions comprise a combination of at least about 10% v/v geraniol, 10% v/v clove oil, and 10% v/v rosemary oil.

In some embodiments, disclosed compositions comprise a combination of about 1-20% v/v geraniol, 1-20% v/v clove oil, and 1-20% v/v rosemary oil, inclusive. In some embodiments, disclosed compositions comprise a combination of about 1-10% v/v geraniol, 1-10% v/v clove oil, and 1-10% v/v rosemary oil, inclusive. In some embodiments, disclosed compositions comprise a combination of about 1-5% v/v geraniol, 1-5% v/v clove oil, and 1-5% v/v rosemary oil, inclusive.

In some embodiments, disclosed compositions comprise a combination of up to about 20% v/v geraniol, 20% v/v clove oil, and 20% v/v rosemary oil. In some embodiments, disclosed compositions comprise a combination of up to about 10% v/v geraniol, 10% v/v clove oil, and 10% v/v rosemary oil. In some embodiments, disclosed compositions comprise a combination of about 5% v/v geraniol, 5% v/v clove oil, and 5% v/v rosemary oil.

In some embodiments, disclosed compositions comprise a combination of geraniol, a clove extract, a rosemary extract, and a cedarwood extract. In some embodiments, disclosed compositions comprise a combination of geraniol, a clove extract, a rosemary extract, and a cedarwood extract in equivalent amounts, such as in a volume ratio of about 1:1:1:1. In some embodiments, disclosed compositions comprise a combination of geraniol, a clove extract, a rosemary extract, and a cedarwood extract in different amounts. In preferred embodiments, the extract is an oil.

In some embodiments, disclosed compositions comprise a combination of cedarwood oil, clove oil, geraniol, and rosemary oil. In some embodiments, disclosed compositions comprise a combination of combination of cedarwood oil, clove oil, geraniol, and rosemary oil in equivalent amounts, such as in a volume ratio of about 1:1:1:1. In some embodiments, disclosed compositions comprise a combination of cedarwood oil, clove oil, geraniol, and rosemary oil in different amounts.

In some embodiments, disclosed compositions comprise a combination of cedarwood oil, clove oil, geraniol, and rosemary oil in a volume ratio of about 1:1:1:1, 1:1:1:2, 1:1:1:3, 1:1:1:4, 1:1:1:5, 1:1:2:2, 1:1:2:3, 1:1:2:4, 1:1:2:5, 1:1:3:3, 1:1:3:4, 1:1:3:5, 1:1:4:4, 1:1:4:5, 1:1:5:5, 1:2:2:2, 1:2:2:3, 1:2:2:4, 1:2:2:5, 1:2:3:3, 1:2:3:4, 1:2:3:5, 1:2:4:4, 1:2:4:5, 1:2:5:5, 1:3:3:3, 1:3:3:4, 1:3:3:5, 1:3:4:4, 1:3:4:5, 1:3:5:5, 1:4:4:4, 1:4:4:5, 1:4:5:5, 1:5:5:5, 2:2:2:2, 2:2:2:3, 2:2:2:4, 2:2:2:5, 2:2:3:3, 2:2:3:4, 2:2:3:5 2:2:4:4, 2:2:4:5, 2:2:5:5, 2:3:3:3, 2:3:3:4, 2:3:3:5, 2:3:4:4, 2:3:4:5, 2:3:5:5, 2:4:4:4, 2:4:4:5, 2:4:5:5, 2:5:5:5, 3:3:3:3, 3:3:3:4, 3:3:3:5, 3:3:4:4, 3:3:4:5, 3:3:5:5, 3:4:4:4, 3:4:4:5, 3:4:5:5, 3:5:5:5, 4:4:4:4, 4:4:4:5, 4:4:5:5, 4:5:5:5, or 5:5:5:5, respectively.

In some embodiments, disclosed compositions comprise a combination of at least about 0.1% v/v clove oil, 0.1% v/v geraniol, and 0.1% v/v rosemary oil. In some embodiments, disclosed compositions comprise a combination of at least about 1% v/v clove oil, 1% v/v geraniol, and 1% v/v rosemary oil. In some embodiments, disclosed compositions comprise a combination of at least about 5% v/v clove oil, 5% v/v geraniol, and 5% v/v rosemary oil. In some embodiments, disclosed compositions comprise a combination of at least about 10% v/v clove oil, 10% v/v geraniol, and 10% v/v rosemary oil.

In some embodiments, disclosed compositions comprise a combination of about 1-20% v/v cedarwood oil, 1-20% v/v clove oil, 1-20% v/v geraniol, and 1-20% v/v rosemary oil, inclusive. In some embodiments, disclosed compositions comprise a combination of about 1-10% v/v cedarwood oil, 1-10% v/v clove oil, 1-10% v/v geraniol, and 1-10% v/v rosemary oil, inclusive. In some embodiments, disclosed compositions comprise a combination of about 1-5% v/v cedarwood oil, 1-5% v/v clove oil, 1-5% v/v geraniol, and 1-5% v/v rosemary oil, inclusive.

In some embodiments, disclosed compositions comprise a combination of at least about 0.1% v/v cedarwood oil, 0.1% v/v clove oil, 0.1% v/v geraniol, and 0.1% v/v rosemary oil. In some embodiments, disclosed compositions comprise a combination of at least about 1% v/v cedarwood oil, 1% v/v clove oil, 1% v/v geraniol, and 1% v/v rosemary oil. In some embodiments, disclosed compositions comprise a combination of at least about 5% v/v cedarwood oil, 5% v/v clove oil, 5% v/v geraniol, and 5% v/v rosemary oil. In some embodiments, disclosed compositions comprise a combination of at least about 10% v/v cedarwood oil, 10% v/v clove oil, 10% v/v geraniol, and 10% v/v rosemary oil.

In some embodiments, disclosed compositions comprise a combination of about 1-20% v/v cedarwood oil, 1-20% v/v clove oil, 1-20% v/v geraniol, and 1-20% v/v rosemary oil, inclusive. In some embodiments, disclosed compositions comprise a combination of about 1-10% v/v cedarwood oil, 1-10% v/v clove oil, 1-10% v/v geraniol, and 1-10% v/v rosemary oil, inclusive. In some embodiments, disclosed compositions comprise a combination of about 1-5% v/v cedarwood oil, 1-5% v/v clove oil, 1-5% v/v geraniol, and 1-5% v/v rosemary oil, inclusive.

In some embodiments, disclosed compositions comprise a combination of up to about 20% v/v geraniol, 20% v/v clove oil, 20% cedarwood oil, and 20% v/v rosemary oil. In some embodiments, disclosed compositions comprise a combination of up to about 10% v/v geraniol, 10% v/v clove oil, 10% cedarwood oil, and 10% v/v rosemary oil. In some embodiments, disclosed compositions comprise a combination of about 5% v/v geraniol, 5% v/v clove oil, 5% cedarwood oil, and 5% v/v rosemary oil.

### Additional Ingredients

In some embodiments, disclosed compositions further comprise a horticultural oil. In some embodiments, the horticultural oil is derived, such as extracted from a seed or a nut described herein, such as a Brassica napus (rapeseed), Cannabis sativa (hemp seed), Carum carvi (caraway seed), Coriandrum sativum (coriander seed), Cucurbita pepo (also referred to as Cucurbita maxima or Cucurbita moschata) (pumpkin seed), Cuminum cyminum (cumin seed), Foeniculum vulgare (fennel seed), Gossypium herbaceum (cottonseed), Gossypium hirsutum (cottonseed), Helianthus annuus (sunflower seed), Linum usitatissimum (flax seed), Nigella sativa (black cumin seed), Piper nigrum (black pepper seed), Salvia hispanica (chia seed), or Sesamum indicum (sesame seed), Arachis hypogaea (peanut), Corylus avellana (hazelnut), Juglans regia (walnut), Prunus dulcis (almond), including combinations thereof. In preferred embodiments, the horticultural oil comprises a Sesamum extract, such as sesame seed oil.

Spiracle-blocking resulting in asphyxiation is recognized as the primary mechanism of action of horticultural oils. A horticultural oil is sometimes referred to as a dormant oil or a summer oil, with reference to the time of season the oil is used, or a supreme or superior oil. Horticultural oils may be petroleum-based, such as a mineral oil, or derived from botanical seeds and nuts, such as a vegetable oil. See, e.g., Robinson, “Horticultural Oils and Pest Control. Texas Agricultural Extension Service, The Texas A&M University System and Cranshaw & Baxendale, Insect Control: Horticultural Oils—5.569, Revised 2013, Colorado State University Extension. In some cases, the horticultural oil may act as a smotherant while also including at least one bioactive compound that promotes toxicity in an insect pest, e.g., sesame seed oil which can be leveraged for its activity as a smotherant and its bioactivity, e.g., toxicity attributed to sesamolin. In some examples, a horticultural oil is combined with an insecticide, such as a synthetic insecticide, to enhance pesticidal activity.

In some embodiments, disclosed compositions further comprise a preservative. In some embodiments, the preservative is or comprises an antimicrobial agent, an antioxidant, a pH adjuster, a UV absorber, and combinations thereof.

In some embodiments, disclosed compositions further comprise a preservative in an amount of less than about 25% (w/v), less than 20% (w/v), less than 15% (w/v), less than 10% (w/v), or less than 5% (w/v). In some embodiments, disclosed compositions further comprise a preservative in an amount of 0.1-20% (w/v), 0.1-15% (w/v), 0.1-10% (w/v), 0.1-5% (w/v), 0.1-1% (w/v), 0.1-0.5% (w/v), 0.5-20% (w/v), 0.5-15% (w/v), 0.5-10% (w/v), 0.5-5% (w/v), 0.5-1% (w/v), 1-20% (w/v), 1-15% (w/v), 1-10% (w/v), or 1-5% (w/v). In some embodiments, disclosed compositions further comprise a preservative in an amount of about 0.1% (w/v), 0.5% (w/v), 1% (w/v), 1.5% (w/v), 2% (w/v), 2.5% (w/v), 3% (w/v), 3.5% (w/v), 4% (w/v), 4.5% (w/v), 5% (w/v), 5.5% (w/v), 6% (w/v), 6.5% (w/v), 7% (w/v), 7.5% (w/v), 8% (w/v), 8.5% (w/v), 9% (w/v), 9.5% (w/v), or 10% (w/v).

In some embodiments, disclosed compositions further comprise a preservative in an amount of less than about 25% (v/v), less than 20% (v/v), less than 15% (v/v), less than 10% (v/v), or less than 5% (v/v). In some embodiments, disclosed compositions further comprise a preservative in an amount of 0.1-35% (v/v), 0.1-30% (v/v), 0.1-25% (v/v), 0.1-20% (v/v), 0.1-15% (v/v), 0.1-10% (v/v), 0.1-5% (v/v), 0.1-1% (v/v), 0.1-0.5% (v/v), 0.5-35% (v/v), 0.5-30% (v/v), 0.5-25% (v/v) 0.5-20% (v/v), 0.5-15% (v/v), 0.5-10% (v/v), 0.5-5% (v/v), 0.5-1% (v/v), 1-35% (v/v), 1-30% (v/v), 1-25% (v/v), 1-20% (v/v), 1-15% (v/v), 1-10% (v/v), 1-5% (v/v), 5-35% (v/v), 5-30% (v/v), 5-25% (v/v), 5-20% (v/v), 5-15% (v/v), 5-10%, 10-35% (v/v), 10-30% (v/v), 10-25% (v/v), 10-20% (v/v), 10-15% (v/v), 15-35% (v/v), 15-30% (v/v), 15-25% (v/v), or 15-20% (v/v). In some embodiments, disclosed compositions further comprise a preservative in an amount of about 0.1% (v/v), 0.5% (v/v), 1% (v/v), 1.5% (v/v), 2% (v/v), 2.5% (v/v), 3% (v/v), 3.5% (v/v), 4% (v/v), 4.5% (v/v), 5% (v/v), 5.5% (v/v), 6% (v/v), 6.5% (v/v), 7% (v/v), 7.5% (v/v), 8% (v/v), 8.5% (v/v), 9% (v/v), 9.5% (v/v), or 10% (v/v).

In some embodiments, the antimicrobial agent is or comprises benzalkonium chloride, phenoxyethanol, potassium sorbate, propionic acid, sorbic acid, sodium benzoate, or a combination thereof. In some embodiments, the antimicrobial agent comprises an alcohol. In some embodiments, the alcohol is ethyl alcohol, isopropyl alcohol, denatured alcohol, benzyl alcohol, propylene glycol, glycerin, a derivative thereof, or a combination thereof.

In some embodiments, the antioxidant is or comprises ascorbic acid (vitamin C), butylated hydroxyanisole (BHA), butylated hydroxytoluene (BHT), epigallocatechin gallate, tocotrienols, a derivative thereof, or a combination thereof.

In some embodiments, the pH adjuster is or comprises citric acid, lactic acid, phosphoric acid, sodium citrate, sodium hydroxide, a derivative thereof, or a combination thereof.

In some embodiments, disclosed compositions comprise a preservative that is or comprises caprylhydroxamic acid, dehydroacetic acid, a paraben, such as ethylparaben, methylparaben, or propylparaben, sodium levulinate, a derivative thereof, or a combination thereof.

In some embodiments, disclosed compositions further comprise a surfactant. The surfactant may serve as a penetrant, such as a penetration enhancer. In some embodiments, the surfactant is selected from the group consisting of an amphoteric surfactant, an anionic surfactant, a cationic surfactant, an oil surfactant, and combinations thereof.

In some embodiments, disclosed compositions further comprise a surfactant in an amount of less than about 25% (w/v), less than 20% (w/v), less than 15% (w/v), less than 10% (w/v), or less than 5% (w/v). In some embodiments, disclosed compositions further comprise a surfactant in an amount of 0.1-20% (w/v), 0.1-15% (w/v), 0.1-10% (w/v), 0.1-5% (w/v), 0.1-1% (w/v), 0.1-0.5% (w/v), 0.5-20% (w/v), 0.5-15% (w/v), 0.5-10% (w/v), 0.5-5% (w/v), 0.5-1% (w/v), 1-20% (w/v), 1-15% (w/v), 1-10% (w/v), or 1-5% (w/v). In some embodiments, disclosed compositions further comprise a surfactant in an amount of about 0.1% (w/v), 0.5% (w/v), 1% (w/v), 1.5% (w/v), 2% (w/v), 2.5% (w/v), 3% (w/v), 3.5% (w/v), 4% (w/v), 4.5% (w/v), 5% (w/v), 5.5% (w/v), 6% (w/v), 6.5% (w/v), 7% (w/v), 7.5% (w/v), 8% (w/v), 8.5% (w/v), 9% (w/v), 9.5% (w/v), or 10% (w/v).

In some embodiments, disclosed compositions further comprise a surfactant in an amount of less than about 25% (v/v), less than 20% (v/v), less than 15% (v/v), less than 10% (v/v), or less than 5% (v/v). In some embodiments, disclosed compositions further comprise a surfactant in an amount of 0.1-20% (v/v), 0.1-15% (v/v), 0.1-10% (v/v), 0.1-5% (v/v), 0.1-1% (v/v), 0.1-0.5% (v/v), 0.5-20% (v/v), 0.5-15% (v/v), 0.5-10% (v/v), 0.5-5% (v/v), 0.5-1% (v/v), 1-20% (v/v), 1-15% (v/v), 1-10% (v/v), or 1-5% (v/v). In some embodiments, disclosed compositions further comprise a surfactant in an amount of about 0.1% (v/v), 0.5% (v/v), 1% (v/v), 1.5% (v/v), 2% (v/v), 2.5% (v/v), 3% (v/v), 3.5% (v/v), 4% (v/v), 4.5% (v/v), 5% (v/v), 5.5% (v/v), 6% (v/v), 6.5% (v/v), 7% (v/v), 7.5% (v/v), 8% (v/v), 8.5% (v/v), 9% (v/v), 9.5% (v/v), or 10% (v/v).

In some embodiments, the amphoteric surfactant is or comprises cocamidopropyl betaine, disodium cocoamphodiacetate, lauryl betaine, a derivative thereof, or a combination thereof.

In some embodiments, the anionic surfactant is or comprises an alkyl sufate, such as sodium dodecyl sulfate (SDS), sodium lauryl sulfate (SLS), sodium laureth sulfate (SLES), or a combination thereof.

In some embodiments, the cationic surfactant is or comprises benzalkonium chloride, cetyltrimethylammonium chloride (CTAC), dodecylbenzenesulfonic acid, a derivative thereof, or a combination thereof.

In some embodiments, the oil surfactant is a nonionic surfactant. In some embodiments, the oil surfactant is or comprises glyceryl oleate, lecithin, a polysorbate, such as polysorbate 20 (Tween 20), polysorbate 80, (Tween 80), a sorbitan ester, such as sorbitan monostearate or sorbitan monooleate, soybean oil, a sucrose ester, such as sucrose palmitate or sucrose stearate, a derivative thereof, or a combination thereof.

In some embodiments, disclosed compositions repel insects, such as mosquitoes, flies, ants, cockroaches, aphids, beetles, moths, ticks, fleas, bed bugs, mites, silverfish, gnats, caterpillars, termites, and combinations thereof. In some embodiments, disclosed compositions are toxic to insects, such as mosquitoes, flies, ants, cockroaches, aphids, beetles, moths, ticks, fleas, bed bugs, mites, silverfish, gnats, caterpillars, termites, and combinations thereof.

In some embodiments, disclosed compositions are toxic to mosquitoes, such as having any of ovicidal, larvicidal, pupicidal, and adulticidal activity against mosquitoes. In some embodiments, disclosed compositions are toxic to a mosquito. In some embodiments, the mosquito belongs to the genus Aedes, Anopheles, Culex, Culiseta, Coquillettidia, or Psorophora. In some embodiments, the mosquito(es) is/are selected from the group consisting of Aedes aegypti, Aedes albopictus, Anopheles freeborni, Anopheles quadrimaculatus, Culex pipiens, Culex quinquefasciatus, Culex restuans, Culex salinarius, Culex tarsalis, Culiseta inornate, Culiseta melaura, Coquillettidia perturbans, Psorophora ciliata, Psorophora columbiae, and combinations thereof.

### Uses and Applications

In some aspects, provided herein are methods of using disclosed compositions. In some embodiments, disclosed methods comprise using disclosed compositions to control an insect population. In some embodiments, controlling an insect population comprises any of repelling an insect, incapacitating an insect, and killing an insect.

In some embodiments, disclosed methods comprise controlling an insect population by contacting an insect from the insect population with a disclosed composition. In other embodiments, disclosed methods comprise controlling an insect population by repelling an insect from the insect population with a disclosed composition. In some embodiments, the insect population comprises an organism from the order Acari, Araneae, Blattodea, Diptera, Hemiptera, Hymenoptera, Lepidoptera, Ixodida (Acari), Scorpiones, or Thysanurs. In some embodiments, the insect population comprises a mosquito, a fly, an ant, a cockroach, an aphid, a beetle, a moth, a tick, a flea, a bed bug, a mite, a silverfish, a gnat, a caterpillar, a termite, a spider, a scorpion, or a combination thereof.

In some embodiments, the insect belongs to the order Acari, Araneae, Blattodea, Diptera, Hemiptera, Hymenoptera, Lepidoptera, Ixodida (Acari), Scorpiones, or Thysanurs. In some embodiments, the insect is a mosquito, a fly, an ant, a cockroach, an aphid, a beetle, a moth, a tick, a flea, a bed bug, a mite, a silverfish, a gnat, a caterpillar, a termite, a spider, or a scorpion.

In some embodiments, disclosed methods comprise controlling a mosquito population by contacting a mosquito with a disclosed composition. In other embodiments, disclosed methods comprise controlling a mosquito population by repelling a mosquito with a disclosed composition. In some embodiments, the mosquito population comprises a mosquito or mosquitoes belonging to the genus selected from the group consisting of Aedes, Anopheles, Culex, Culiseta, Coquillettidia, or Psorophora, and combinations thereof. In some embodiments, the mosquito population comprises a mosquito or mosquitoes selected from the group consisting of Aedes aegypti, Aedes albopictus, Anopheles freeborni, Anopheles quadrimaculatus, Culex pipiens, Culex quinquefasciatus, Culex restuans, Culex salinarius, Culex tarsalis, Culiseta inornate, Culiseta melaura, Coquillettidia perturbans, Psorophora ciliata, Psorophora columbiae, and combinations thereof.

In some embodiments, contacting the insect population comprises fumigating the insect population with a disclosed composition. In some embodiments, contacting the insect population comprises coating or spraying a surface with a disclosed composition, where the surface may be contacted by an insect in the insect population or is available for contact by an insect in the insect population. In some embodiments, contacting the insect does not comprise fumigation. In preferred embodiments, contacting the insect comprises coating a surface that may be contacted by an insect in an insect population or is available for contact by the insect in the insect population with a disclosed composition. In some embodiments, the insect does not contact the surface and is repelled by the disclosed composition.

In some embodiments, disclosed methods comprise controlling an insect population by contacting a surface available to the insect population with a disclosed composition only once, such as a total of one time. In some embodiments, contacting the surface with a disclosed composition comprises applying the disclosed composition, such as coating, covering, dusting, finishing, glazing, layering, or spraying, the disclosed composition onto the surface. In some embodiments, the surface is an indoor surface. In some embodiments, the surface is an outdoor surface.

In other embodiments, disclosed methods comprise controlling an insect population by repeatedly contacting a surface available to the insect population with a disclosed composition. In some embodiments, repeatedly contacting the surface comprises applying, such as coating, covering, dusting, finishing, glazing, layering, or spraying, the disclosed composition onto the surface at least about once, twice, three times, four times, or five times per month. In some embodiments, disclosed methods comprise applying the disclosed composition to the surface o once, twice, three times, four times, or five times per month. In preferred embodiments, disclosed methods comprise applying the disclosed composition to the surface only once per month. In some embodiments, the surface is an indoor surface. In some embodiments, the surface is an outdoor surface.

In some embodiments, disclosed methods comprise controlling an insect population by repeatedly contacting a surface available to the insect population with a disclosed composition. In some embodiments, repeatedly contacting the surface comprises applying, such as coating, covering, dusting, finishing, glazing, layering, or spraying, the disclosed composition onto the surface at least about every (1) week, at least about every two weeks, at least about every three weeks, at least about every four weeks, at least about every five weeks, at least about every six weeks, at least about every seven weeks, at least about every eight weeks, at least about every nine weeks, or at least about every ten weeks. In preferred embodiments, disclosed methods comprise applying the disclosed composition onto the surface at least about every three weeks, at least about every four weeks, or at least about every five weeks.

In some embodiments, repeatedly contacting the surface comprises applying, such as coating, covering, dusting, finishing, glazing, layering, or spraying, the disclosed composition onto the surface about every 2 days, every 3 days, every 4 days, every 5 days, every 6 days, every 7 days, every 8 days, every 9 days, every 10 days, every 11 days, every 12 days, every 13 days, every 14 days, every 15 days, every 16 days, every 17 days, every 18 days, every 19 days, every 20 days, every 21 days, every 22 days, every 23 days, every 24 days, every 25 days, every 26 days, every 27 days, every 28 days, every 29 days, every 30 days, every 31 days, every 32 days, every 33 days, every 34 days, every 35 days, every 36 days, every 37 days, every 38 days, every 39 days, every 40 days, every 41 days, every 42 days, every 43 days, every 44 days, every 45 days, every 46 days, every 47 days, every 48 days, every 49 days, every 50 days, every 51 days, every 52 days, every 53 days, every 54 days, every 55 days, every 56 days, every 57 days, every 58 days, every 59 days, every 60 days. In preferred embodiments, disclosed methods comprise applying the disclosed composition onto the surface about every 26 days, every 27 days, every 28 days, every 29 days, every 30 days, every 31 days, or every 32 days.

### EXAMPLES

### Example 1: Effects of Residual Plant-Based Pesticides on Mosquito Survival

Distinct from fumigation, indoor and outdoor surfaces are potential points of contact with insect pests that can be leveraged to exert pesticidal activity. Studying the residual activity of a pesticide coating on a surface over time can provide insight into insecticidal activity, e.g., the time interval necessary for treatment of the surface to maintain efficacy.

Exemplary botanical oil compositions including extracts of Juniperus, Mentha, Sesamum, Syzgium, Thymus, and combinations thereof: In order to test the pesticidal activity of cedarwood essential oil, clove essential oil, peppermint essential oil, sesame seed oil, thyme essential oil, and combinations thereof, contact bioefficacy studies were conducted in accordance with the Environmental Protection Agency's “Efficacy Testing for Pesticides Targeting Certain Invertebrate Pests.”

Briefly, glazed tiles were coated with various essential oil compositions. Mixtures of distinct essential oils were blended together according to known methods. Locally captured mosquitoes Aedes vexans and Culex pipiens were contained in a Petri dish covered with netting. The Petri dish was inverted to facilitate contact of the mosquitoes with the pesticide compositions coating the surface of tiles. Tested botanical compositions are shown in Table 2.

TABLE 2
Botanical oils assessed in a residual
efficacy study against mosquitoes

| Essential Oil | Concentration (% v/v) |
|---|---|
| Cedarwood Oil | 10% |
| Clove Oil | 5% |
| Peppermint Oil | 5% |
| Sesame Oil | 5% |
| Thyme Oil | 5% |
| Cedarwood Oil + Sesame Oil | 10%/5% |
| Cedarwood Oil + Clove Oil + Sesame Oil | 10%/5%/5% |
| Cedarwood Oil + Clove Oil + Peppermint | 10%/5%/5%/5% |
| Oil + Sesame Oil | |
| Cedarwood Oil + Clove Oil + Peppermint | 10%/5%/5%/5%/5% |
| Oil + Sesame Oil + Thyme Oil | |

The survival of mosquitoes was determined after contact with tile freshly coated with botanical oil(s) (Day 0), tile coated one week prior (Day 7), tile coated two weeks prior (Day 14), and tile coated three weeks prior (Day 21). In each case, exposure of the mosquitoes to the botanical oil coating was limited to 15 minutes, and mosquito death was observed and recorded during the 15 minute exposure and at 1 hour and 24 hours post-exposure.

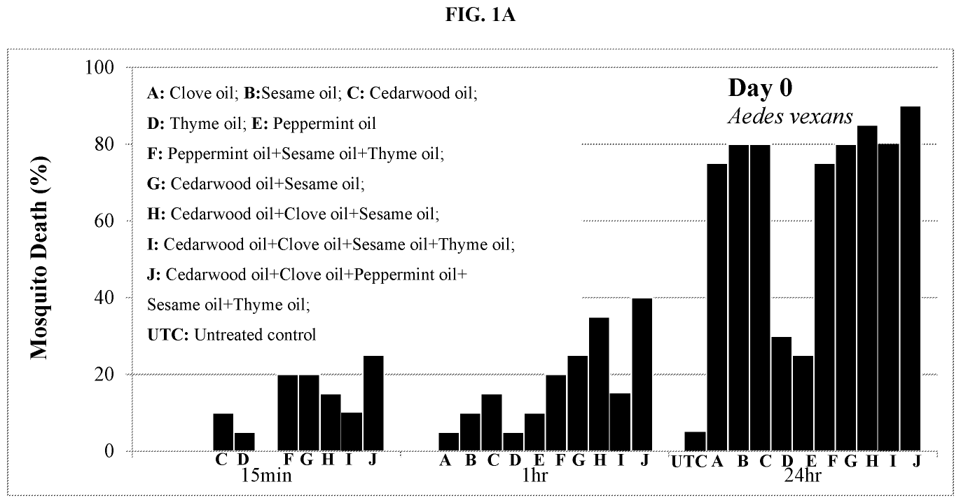

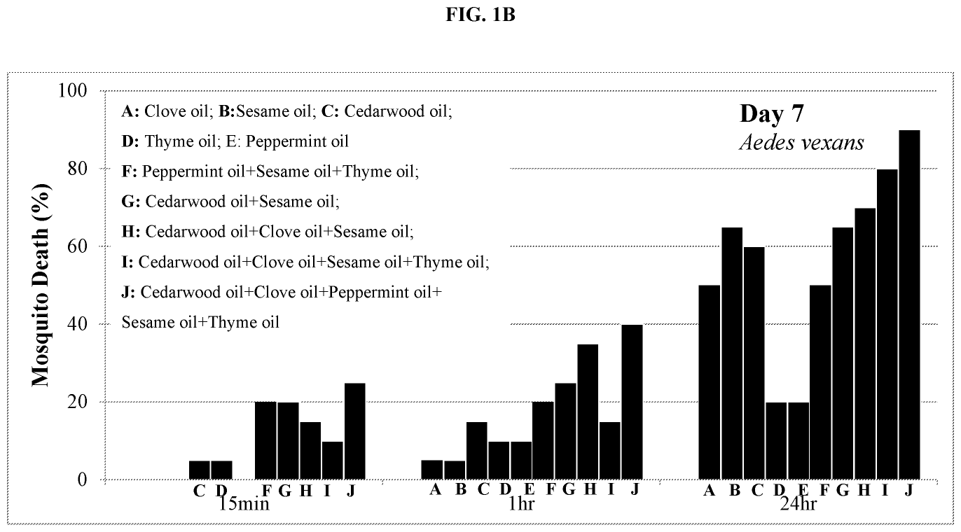

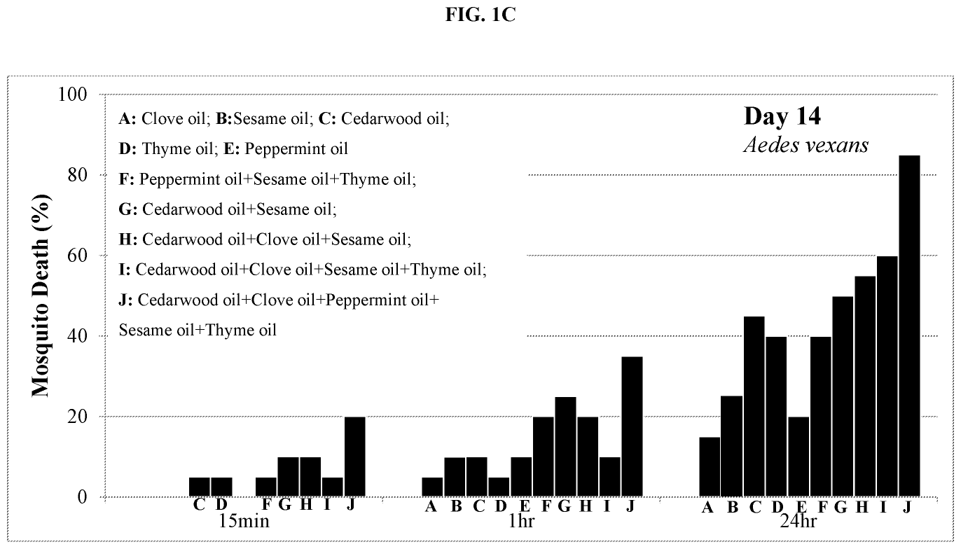

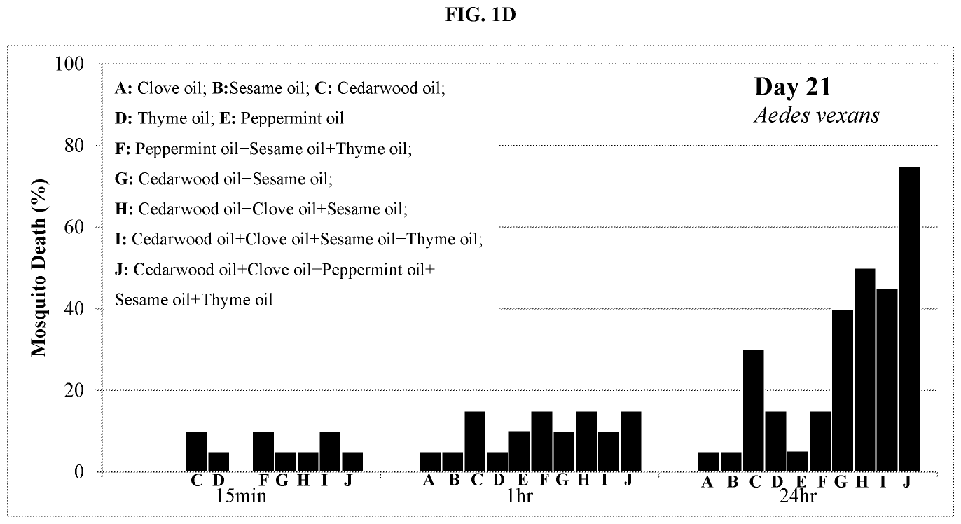

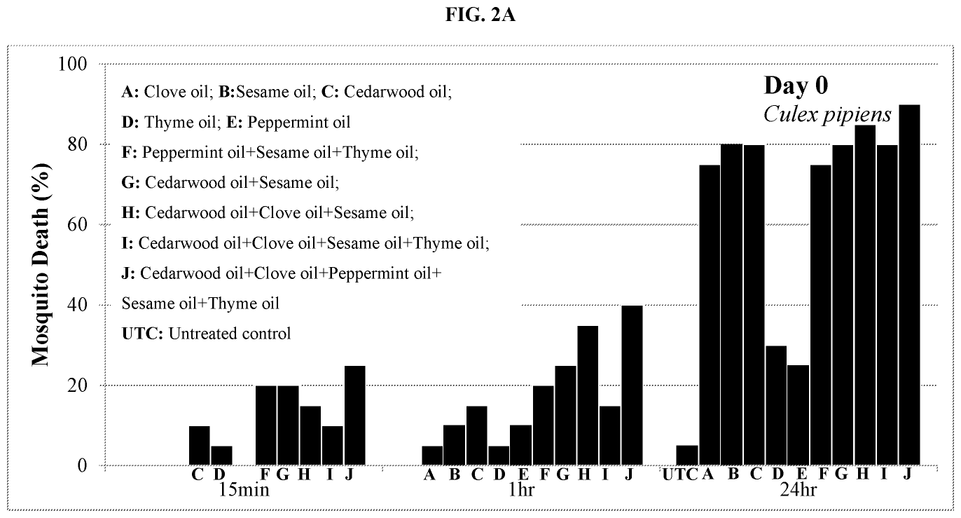

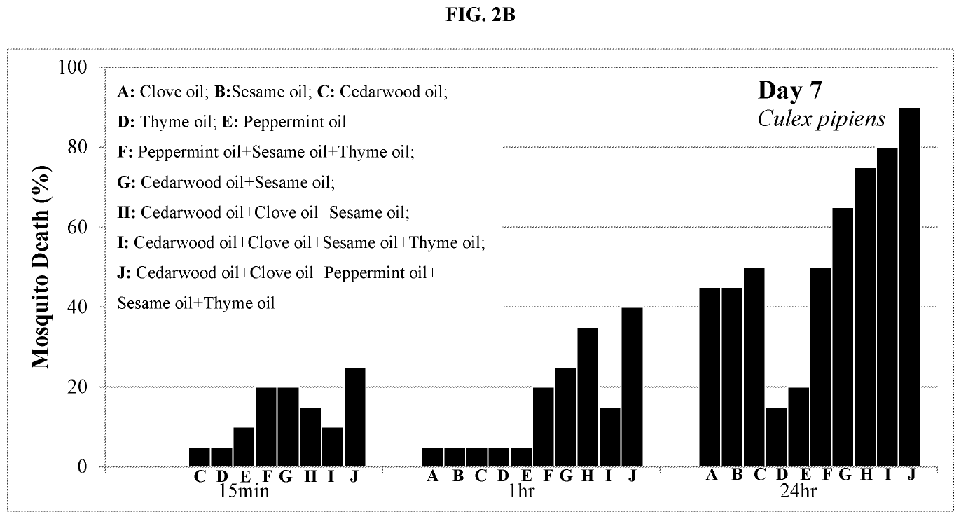

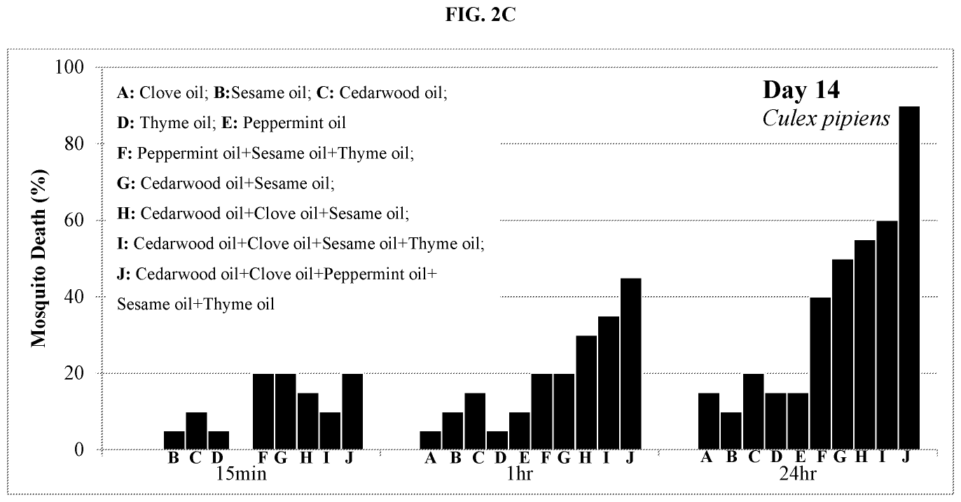

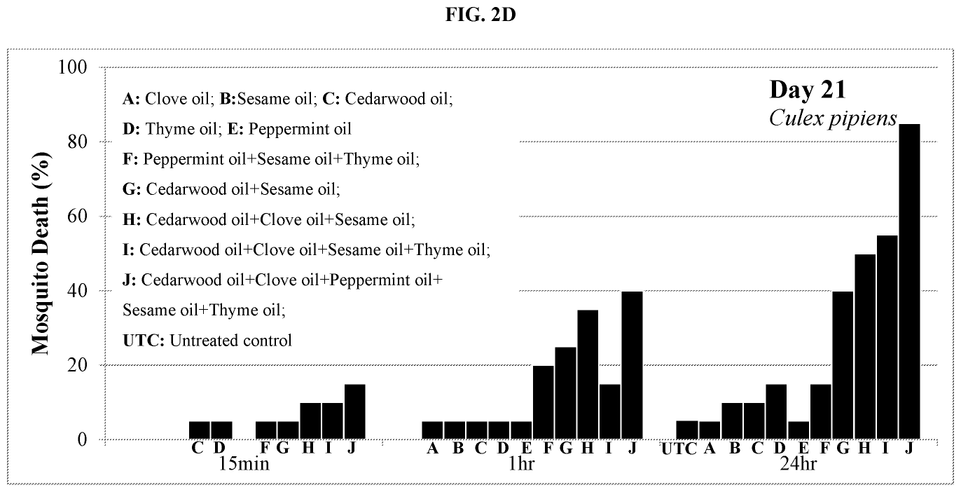

FIG. 1A-FIG. 1D show percent death of Aedes vexans upon exposure to and post-exposure to Day 0 tile (FIG. 1A), Day 7 tile (FIG. 1B), Day 14 tile (FIG. 1C), and Day 21 tile (FIG. 1D). Similarly, FIG. 2A-FIG. 2D show percent death of Culex pipiens upon exposure to and post-exposure to Day 0 tile (FIG. 2A), Day 7 tile (FIG. 2B), Day 14 tile (FIG. 2C), and Day 21 tile (FIG. 2D). Percent mosquito death was normalized to an untreated tile, i.e., a coating without a botanical oil composition notated Untreated Control (UTC). The mortality observed in the UTC group was not sufficient to force an Abbott calculation.

Exposure to the combination of cedarwood oil, clove oil, peppermint oil, sesame oil, and thyme oil (5-oil combination) yielded the highest percentage of mosquito death at each time point across freshly coated tile (Day 0) and previously coated tile (Day 7, Day 14, and Day 21 tiles). At 24 hours post-exposure, the most potent single components of the combination were cedarwood oil (Day 0 tile=80% A. vexans death), clove oil (Day 0 tile=75% A. vexans death), and sesame oil (Day 0 tile=80% A. vexans death), as shown in FIG. 1A. Over time, however, efficacy of the most effective essential oils waned, with the percent mosquito death of cedarwood oil dropping by about 63% (Day 21 tile=30% A. vexans death), that of clove oil reduced by about 93% (Day 21 tile=5% A. vexans death), and that of sesame oil falling by about 94% (Day 21 tile=5% A. vexans death). In contrast, combinations of the essential oils yielded enhanced efficacy. At 24 hours post-exposure to Day 21 tile, the 5-oil combination yielded 75% mosquito death, while the next most potent combinations were cedarwood oil, clove oil, and sesame oil (50% A. vexans death) and cedarwood oil, clove oil, sesame oil, and thyme oil (45% A. vexans). See FIG. 1D.

Notably, although the remaining components of the 5-oil combination, peppermint oil and thyme oil, showed relatively low insecticidal efficacy that faded over time, their presence was necessary to sustain the superior efficacy of the 5-oil combination across groups. For example, at the 24 hour time point, exposure to Day 0 tile coated with peppermint oil resulted in 25% A. vexans death, whereas exposure to Day 21 tile resulted in an 80% reduction in efficacy with 5% A. vexans death. At the 24 hour time point, exposure to Day 0 tile coated with thyme oil yielded 30% A. vexans death, efficacy which was reduced by 50% upon exposure to Day 21 tile (15% A. vexans death).

However, peppermint oil and thyme oil boosted the mosquitocidal efficacy of the combination of cedarwood oil, clove oil, and sesame seed oil by about 29% at 24 hours post-exposure to Day 7 tile (70% vs. 90%), by about 55% at 24 hours post-exposure to Day 14 tile (55% vs. 85%), and by 50% at 24 hours post-exposure to Day 21 tile (50% vs. 75%). See FIG. 1B, FIG. 1C, and FIG. 1D respectively.

These trends were reflected in C. pipiens testing. Initially, 24 hours post-exposure to Day 0 tile, the single most potent oils were cedarwood oil (80% C. pipiens death), clove oil (75% C. pipiens death), and sesame oil (80% C. pipiens death), and efficacy of the three in combination was second only to the 5-oil combination (85% C. pipiens death vs. 90% C. pipiens death), as shown in FIG. 2A.

Again, the efficacy of the most potent oils waned over time, alone and in combination, indicating the presence of peppermint oil and thyme oil as key to maintaining the mosquitocidal superiority of the 5-oil combination. See, e.g., FIG. 2B. Considering previously coated Day 14 (FIG. 2C) and Day 21 tile (FIG. 2D), at 24 hours post-exposure, addition of thyme oil boosted the mosquitocidal efficacy of the mixture of cedarwood oil, clove oil, and sesame oil by about 10%. However, the combination of peppermint oil and thyme oil boosted the efficacy of the same mixture by about 64-70%. Together, these data indicate the superiority of the 5-oil combination, which includes α-cedrene, eugenol, menthol, sesamolin, and thymol, even over the mixture of the most potent single essential oils. These findings show the importance of including peppermint oil to maintain the mosquitocidal efficacy of the 5-oil mixture, which is unexpected in view of the relatively low activity of peppermint oil recognized in the present study and in previous experimentation (e.g., as shown in Table 1).

Exemplary botanical oil compositions including extracts of Juniperus, Pelargonium, Rosmarinus, Syzgium, and combinations thereof: The pesticidal activity of cedarwood essential oil, rosemary oil, clove essential oil, geraniol, and combinations thereof, was evaluated in contact bioefficacy studies in accordance with methods described for the 5-oil combination. Tested botanical compositions are shown in Table 3.

TABLE 3
Botanical oils assessed in a residual
efficacy study against mosquitoes

| Essential Oil | Concentration (% v/v) |
|---|---|
| Clove oil | 5% |
| Rosemary oil | 5% |
| Cedarwood oil | 5% |
| Geraniol | 5% |
| Clove oil + Geraniol | 5%/5% |
| Clove oil + Rosemary oil | 5%/5% |
| Cedarwood oil + Clove oil; | 5%/5% |
| Clove oil + Geraniol + Rosemary oil | 5%/5%/5% |
| Cedarwood oil + Clove | 5%/5%/5%/5% |
| oil + Geraniol + Rosemary oil | |

As conducted previously, the survival of mosquitoes was determined after contact with tile freshly coated with botanical oil(s) (Day 0), tile coated one week prior (Day 7), tile coated two weeks prior (Day 14), and tile coated three weeks prior (Day 21). In each case, exposure of the mosquitoes to the botanical oil coating was limited to 15 minutes, and mosquito death was observed and recorded during the 15 minute exposure and at 1 hour and 24 hours post-exposure.

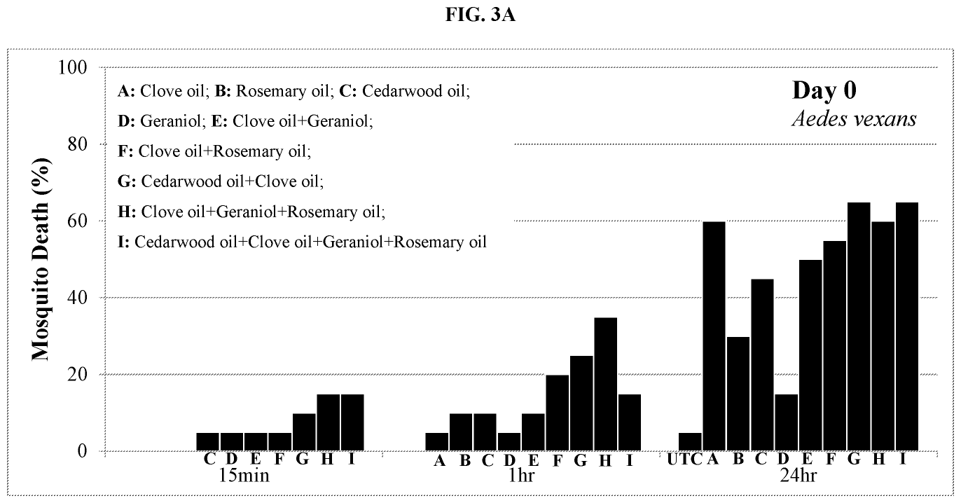

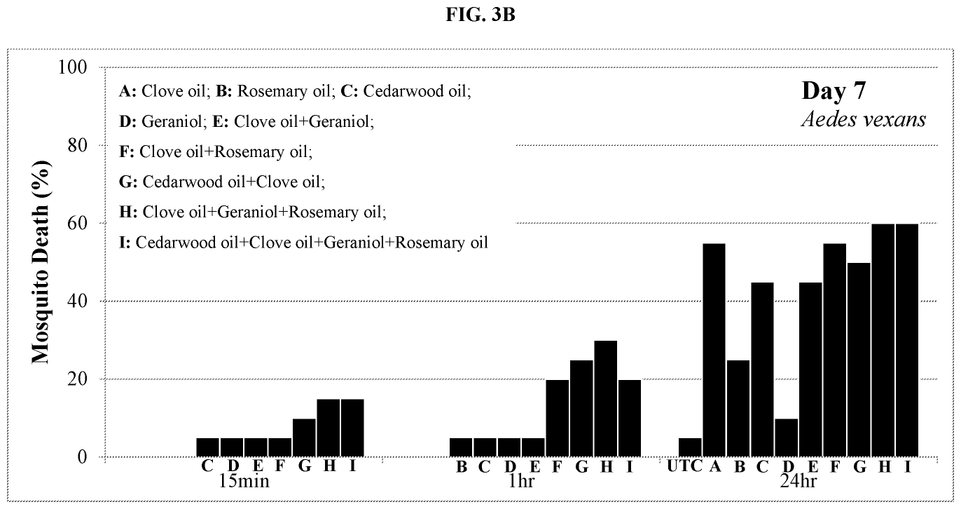

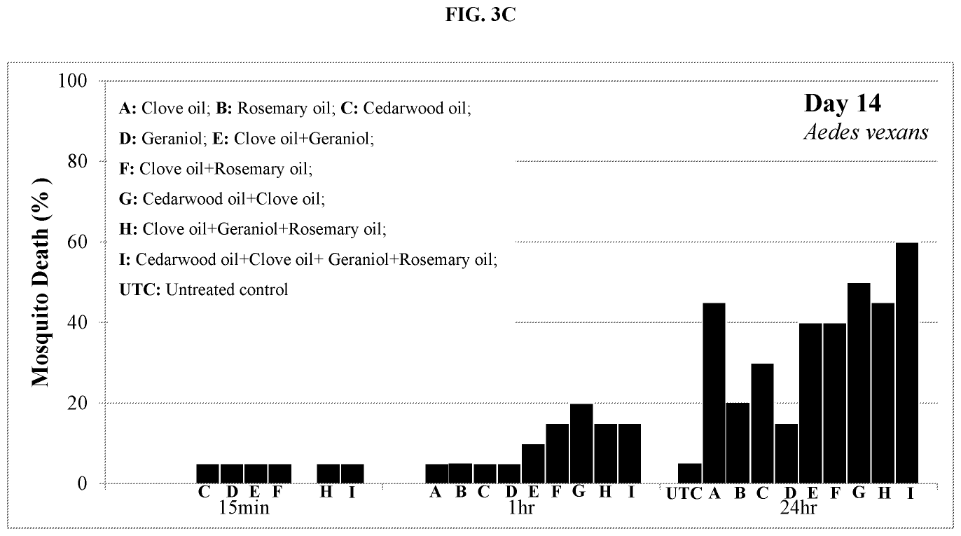

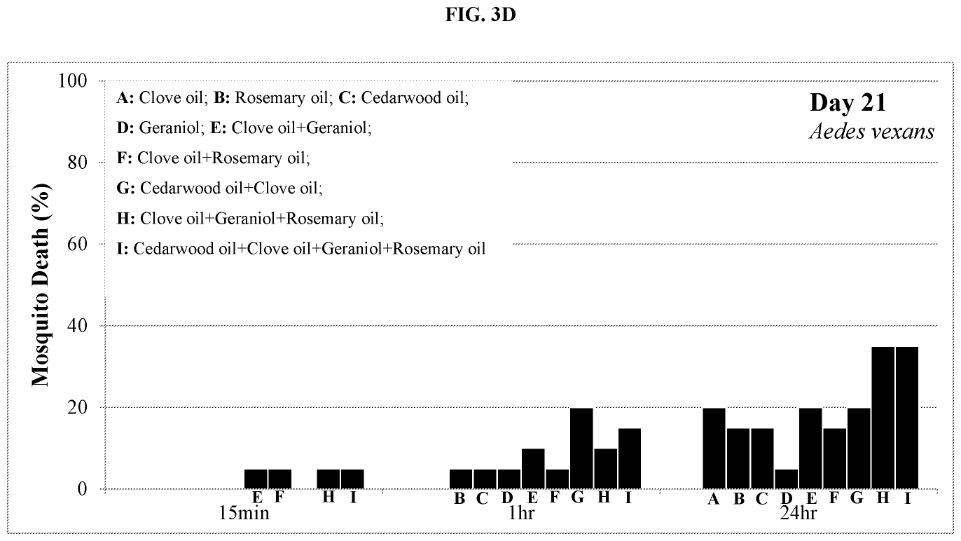

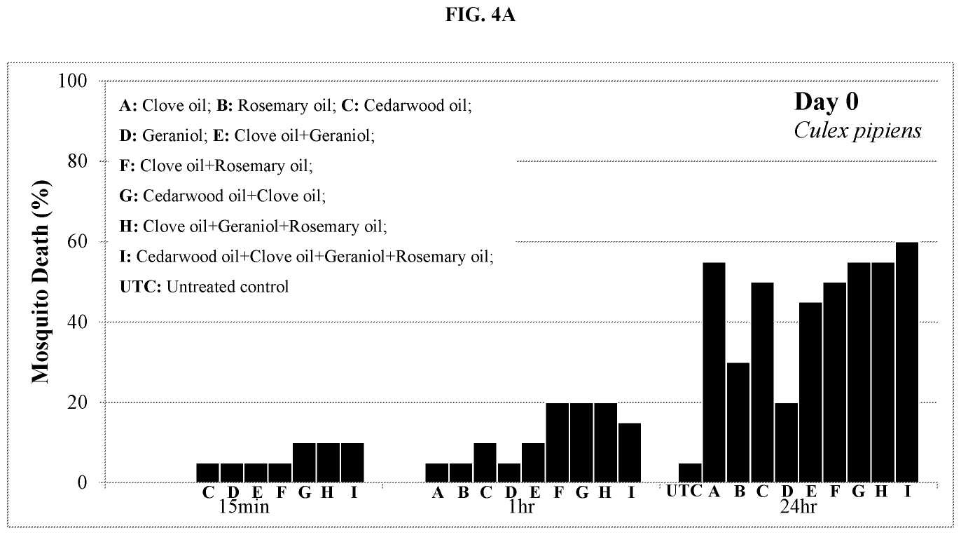

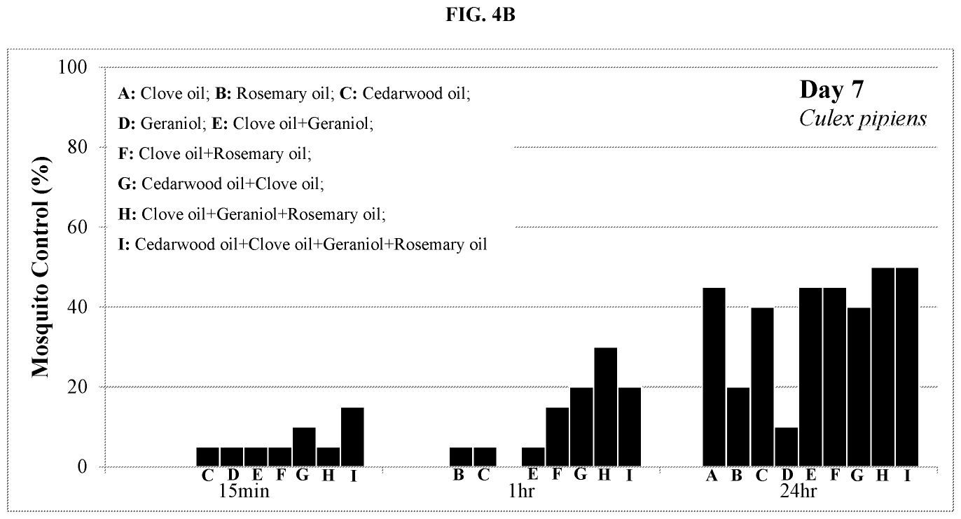

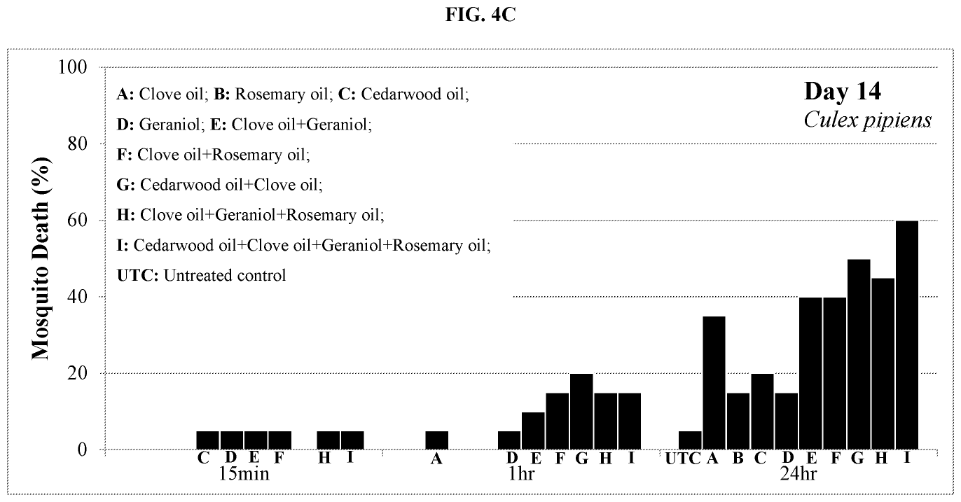

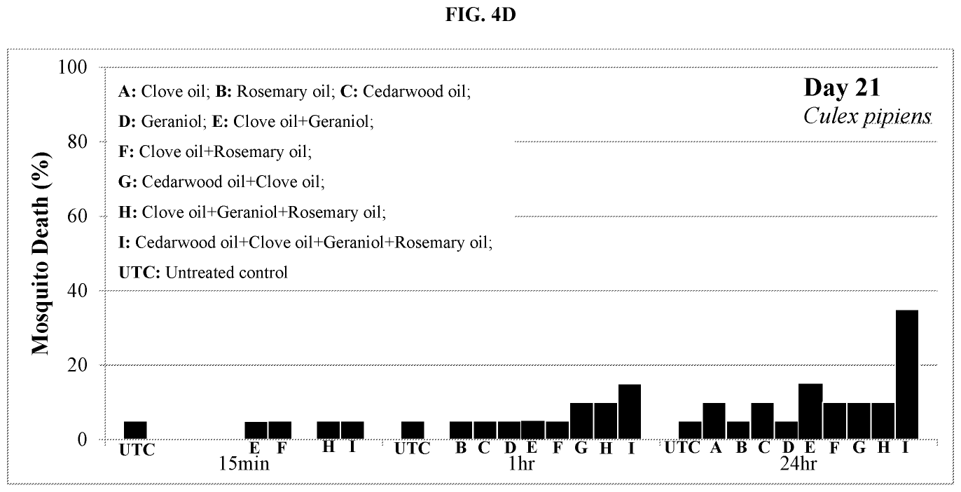

FIG. 3A-FIG. 3D show percent death of Aedes vexans upon exposure to and post-exposure to Day 0 tile (FIG. 3A), Day 7 tile (FIG. 3B), Day 14 tile (FIG. 3C), and Day 21 tile (FIG. 3D). Similarly, FIG. 4A-FIG. 4D show percent death of Culex pipiens upon exposure to and post-exposure to Day 0 tile (FIG. 4A), Day 7 tile (FIG. 4B), Day 14 tile (FIG. 4C), and Day 21 tile (FIG. 4D). Percent mosquito death was normalized to an untreated tile, i.e., a coating without a botanical oil composition notated Untreated Control (UTC). The mortality observed in the UTC group was not sufficient to force an Abbott calculation.

Following contact with freshly coated tile, percent mortality of Aedes vexans mosquitoes was greatest upon initial contact (15%), 1 hr post-exposure (35%), and 24 hrs post-exposure (60%) to botanical oil compositions containing rosemary oil, geraniol, and clove oil. Addition of cedarwood oil to the combination increased percent mortality by 5% (65%), leading to the most effective formulation at the 24 hr time point in the Day 0 group, as shown in FIG. 3A. Across groups Day 7 (FIG. 3B), Day 14 (FIG. 3C), and Day 21 (FIG. 3D), at the 15 minute and 24 hr timepoints, the combination of rosemary oil, geraniol, clove oil, and cedarwood oil maintained the greatest mosquitocidal activity in comparison to the other formulations. At Day 21, where the efficacy of other formulations waned below 20% at the 24 hr timepoint, the mosquitocidal activity of 1) rosemary oil, geraniol, and clove oil and 2) rosemary oil, geraniol, clove oil, and cedarwood oil was maintained, causing 35% mortality.

The enhanced efficacy of botanical oil compositions containing either rosemary oil, geraniol, and clove oil, or rosemary oil, geraniol, clove oil, and cedarwood oil, was similarly observed upon exposure to Culex pipiens mosquitoes across timepoints in groups Day 0 (FIG. 4A), Day 7 (FIG. 4B), Day 14 (FIG. 4C), and Day 21 (FIG. 4D). Together, these data indicate the potent and sustainable mosquitocidal effects of compositions including 1,8-cineole, eugenol, geraniol and α-cedrene.

### EQUIVALENTS AND SCOPE

Those skilled in the art will recognize or be able to ascertain using no more than routine experimentation many equivalents to the specific embodiments described herein. The scope of the present invention is not intended to be limited to the above, but rather is as set forth in the appended claims.

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, it is to be understood that the invention encompasses all variations, combinations, and permutations in which one or more limitations, elements, clauses and descriptive terms, from one or more of the listed claims is introduced into another claim. For example, any claim that is dependent on another claim can be modified to include one or more limitations found in any other claim that is dependent on the same base claim.

Where elements are presented as lists, e.g., in Markush group format, it is to be understood that each subgroup of the elements is also disclosed, and any element(s) can be removed from the group. It should be understood that, in general, where the invention, or aspects of the invention is/are referred to as comprising particular elements, features, etc., certain embodiments of the invention or aspects of the invention consist, or consist essentially of, such elements, features, etc. For purposes of simplicity, those embodiments have not been specifically set forth in haec verba herein. It is also noted that the term “comprising” is intended to be open and permits the inclusion of additional elements or steps.

Where ranges are given, endpoints are included. Furthermore, it is to be understood that unless otherwise indicated or otherwise evident from the context and understanding of one of ordinary skill in the art, values that are expressed as ranged can assume any specific value or sub-range within the stated ranges in different embodiments of the invention, to the tenth of the unit of the lower limit of the range, unless the context clearly dictates otherwise.

The term “about” or “approximately” means within an acceptable error range for the particular value as determined by one of the ordinary skill in the art, which will depend in part on how the value is measured or determined, e.g., the limitations of the measurement system. For example, “about” can mean within 1 or more than 1 standard deviation, per the practice in the art. Alternatively, “about” can mean a range of up to 20%, up to 10%, up to 5% or up to 1% of a given value. Alternatively, the term can mean within an order of magnitude, for example within 5-fold, or within 2-fold, of a value. Where particular values are described in the application and claims, unless otherwise stated the term “about” meaning within an acceptable error range for the particular value should be assumed.

In addition, it is to be understood that any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the method of the invention can be excluded from any one or more claims, for any reason, whether or not related to the existence of prior art.

What is claimed is:

1. A botanical pesticide composition comprising a Juniperus extract and/or a Cedrus extract, a Syzygium extract, and a horticultural oil.

2. The composition of claim 1, further comprising a Mentha extract and/or a Thymus extract.

3. The composition of claim 1, wherein:
a) the Juniperus extract is an oil comprising 10-50% α-cedrene and/or the Cedrus extract is an oil comprising 10-50% α-cedrene;
b) the Syzygium extract is an oil comprising 25-75% eugenol; and
c) the horticultural oil comprises an oil selected from the group consisting of a vegetable oil, a mineral oil, a petroleum oil, and combinations thereof;
and wherein the vegetable oil comprises sesame seed oil comprising 5-25% sesamolin.

4. The composition of claim 2, wherein:
a) the Mentha extract is an oil comprising 20-60% menthol; and
b) the Thymus extract is an oil comprising 25-75% thymol.

5. The composition of claim 1, further comprising a preservative and/or a surfactant.

6. A botanical pesticide composition comprising cedarwood oil, clove oil, and sesame seed oil.

7. The composition of claim 6, further comprising peppermint oil and thyme oil.

8. The composition of claim 6, further comprising an antimicrobial agent and/or a surfactant.

9. The composition of claim 8, wherein the antimicrobial agent is selected from the group consisting of benzoic acid, propionic acid, sorbic acid, and combinations thereof; and the surfactant is selected from the group consisting of sodium dodecyl sulfate (SDS), sodium lauryl sulfate (SLS), sodium laureth sulfate (SLES), and combinations thereof.

10. The botanical pesticide composition of claim 6, wherein:
a) the cedarwood oil comprises 10-50% α-cedrene and is present in a % v/v amount of 0.1%-10%;
b) the clove oil comprises 25-75% eugenol and is present in a % v/v amount of 0.1%-10%; and
c) the sesame oil comprises 5-25% sesamolin and is present in a % v/v amount of 0.1%-10%;
wherein each range is inclusive.

11. The botanical pesticide composition of claim 7, wherein:
a) the peppermint oil comprises 20-60% menthol and is present in a % v/v amount of 0.1%-10%; and
b) the thyme oil comprises 25-75% thymol and is present in a % v/v amount of 0.1%-10%;
wherein each range is inclusive.

12. The composition of claim 9, wherein propionic acid is present in a % v/v amount of 0.1-25% and sodium lauryl sulfate (SLS) is present in a % v/v amount of 0.1-5%, wherein each range is inclusive.

13. A method of controlling an insect population by spraying the composition of claim 4 onto a surface that is contacted or available for contact by the insect population, thereby controlling the insect population.

14. The method of claim 13, wherein controlling the insect population comprises repelling an insect in the insect population, killing an insect in the insect population, or a combination thereof.

15. The method of claim 13, comprising repeatedly spraying the composition of onto the surface.

16. The method of claim 15, wherein the spraying is repeated at least about every one week, at least about every two weeks, at least about every three weeks, at least about every four weeks, at least about every five weeks, or at least about every six weeks.

17. The method of claim 16, wherein spraying the composition onto the surface is repeated about every 7 days, every 14 days, every 21 days, every 28 days, or every 35 days.

18. The method of claim 13, wherein the insect population is a mosquito population.

19. The method of claim 18, wherein the mosquito population comprises a mosquito selected from a genus selected from Aedes, Anopheles, Coquillettidia, Culex, Culiseta, and Psoraphora.

20. The method of claim 19, wherein the mosquito is selected from the group consisting of Aedes aegypti, Aedes albopictus, Anopheles freeborni, Anopheles quadrimaculatus, Culex pipiens, Culex quinquefasciatus, Culex restuans, Culex salinarius, Culex tarsalis, Culiseta inornate, Culiseta melaura, Coquillettidia perturbans, Psorophora ciliata, and Psorophora columbiae.
